(19) United States
(12) Patent Application Publication
(10) Pub. No.: US 2023/0328560 A1
(43) Pub. Date: Oct. 12, 2023

(54) MAC-CE ACTIVATION OF CLI REPORTING

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Huilin XU, Temecula, CA (US); Ahmed Attia ABOTABL, San Diego, CA (US); Wanshi CHEN, San Diego, CA (US); Alexandros MANOLAKOS, Escondido, CA (US); Krishna Kiran MUKKAVILLI, San Diego, CA (US); Hwan Joon KWON, San Diego, CA (US); Tingfang JI, San Diego, CA (US)

(21) Appl. No.: 18/022,131

(22) PCT Filed: Sep. 3, 2021
(86) PCT No.: PCT/US2021/049095

§ 371 Date: Feb. 17, 2023

(30) Foreign Application Priority Data
Sep. 10, 2020 (GR) 20200100547

(51) Int. Cl. H04W 24/08; H04W 24/10; H04W 72/231; H04W 72/11; H04L 5/00

(52) U.S. Cl. CPC H04W 24/08; H04W 24/10; H04W 72/231; H04W 72/11; H04L 5/0051

(57) ABSTRACT

A UE may receive a configuration of one or more SP resources for CLI and/or SI measurement, and receive, from the base station, a MAC-CE activating the configured one or more SP resources for CLI and/or SI measurements. The UE may measure the CLI and/or SI based on interference signal and report a CLI report, including the measured CLI and/or SI to the base station. The UE may estimate average CL based on an average transmission power of the interference signal over multiple slots from an aggressor UE, and the base station may use the estimated average CL to determine CLI for aggressor UE based on CLI reciprocity.

### CROSS REFERENCE TO RELATED APPLICATIONS

This application claims the benefit of and priority to Greek Patent Application Serial No. 20200100547, entitled “METHODS AND APPARATUS FOR MAC-CE ACTIVATION OF CLI REPORTING” and filed on Sep. 10, 2020, which is expressly incorporated by reference herein in its entirety.

### TECHNICAL FIELD

The present disclosure relates generally to communication systems, and more particularly, to a method of wireless communication including a medium access control (MAC) control element (CE) (MAC-CE) activation of cross-link interference (CLI) report.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. A UE may receive a configuration of one or more semi-persistent (SP) resources for a cross-link interference (CLI) or self-interference (SI) measurement, receive a first medium access control (MAC) control element (CE) (MAC-CE) activating at least one configured SP resources for the CLI measurement or SI measurement from a base station, and perform a CLI or SI measurement activity in the at least one configured SP resources activated by the MAC-CE. The UE may report a CLI report, including at least one CLI component measured from at least one interference signal received in the SP resources activated by the MAC-CE to the base station. The UE may estimate average CL based on an average transmission power of the interference signal over multiple slots, and the base station may use the estimated average CL to determine CLI for other UEs based on CLI reciprocity.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIGS. 4A, 4B, and 4C illustrate exemplary modes of full-duplex communication.

FIGS. 5A and 5B illustrate examples of resources that are in-band full-duplex (IBFD).

FIG. 5C illustrates an example of resources for sub-band full-duplex communication.

FIG. 6 is an example of time and frequency resources, including full-duplex resources.

FIGS. 7A and 7B illustrate examples of intra-cell and inter-cell interference.

FIG. 8 illustrates examples of CSI-IM resources relative to full-duplex resources of wireless communication.

FIG. 9 illustrates examples of CSI-IM resources relative to full-duplex resources of wireless communication.

FIGS. 10A and 10B are MAC-CEs for activating the SP CSI-IM resources and SP SRS Resources.

FIG. 11 illustrates a CLI reciprocity between two UEs.

FIG. 12 illustrates a call-flow diagram of wireless communication.

FIG. 13 is a flowchart of a method of wireless communication.

FIG. 14 is a flowchart of a method of wireless communication.

FIG. 15 is a diagram illustrating an example of a hardware implementation for an example apparatus.

FIG. 16 is a flowchart of a method of wireless communication.

FIG. 17 is a flowchart of a method of wireless communication.

FIG. 18 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components, end-user devices, etc. of varying sizes, shapes, and constitution.

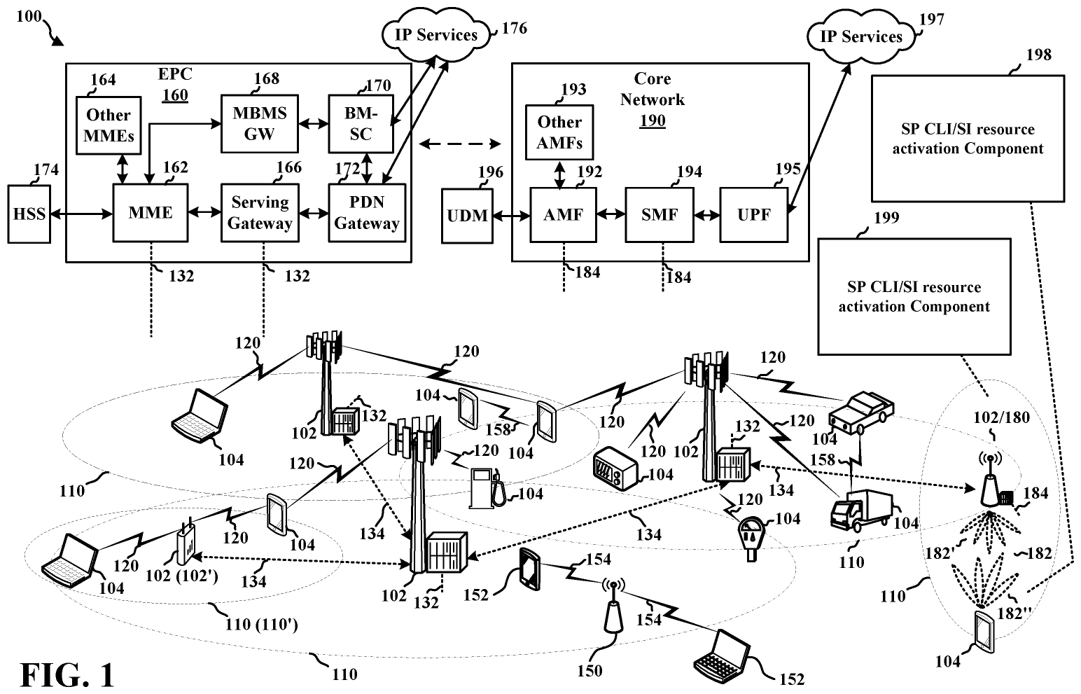

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an SP CLI/SI resource activation component 198 configured to receive, from a base station, a configuration of at least one SP resources for a CLI or SI measurement, receive, from the base station, a first MAC-CE activating at least one configured SP resources for the CLI measurement or SI measurement, perform a CLI or SI measurement activity in the at least one configured SP resources activated by the MAC-CE, and report, to the base station, a CLI report including at least one CLI component measured from at least one interference signal received in the SP resources activated by the MAC-CE. In certain aspects, the base station 180 may include an SP CLI/SI resource activation component 199 configured to configure, for a first UE, at least one SP resources for a CLI or SI measurement, transmit, to the first UE, a first MAC-CE activating at least one configured SP resource for the CLI or SI measurement, and receive from the first UE, a CLI report including at least one CLI component measured from at least one interference signal received in the SP resources activated by the MAC-CE. Although the following description may be focused on 5G NR, the concepts described herein may be applicable to other similar areas, such as LTE, LTE-A, CDMA, GSM, and other wireless technologies.

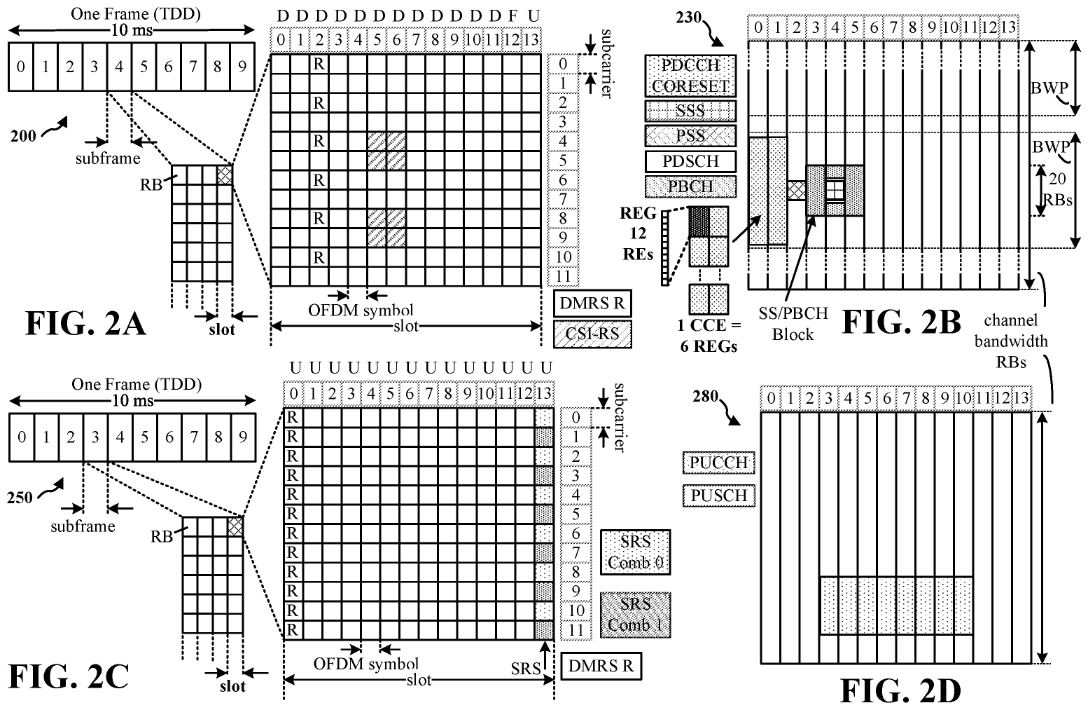

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| μ | SCS Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

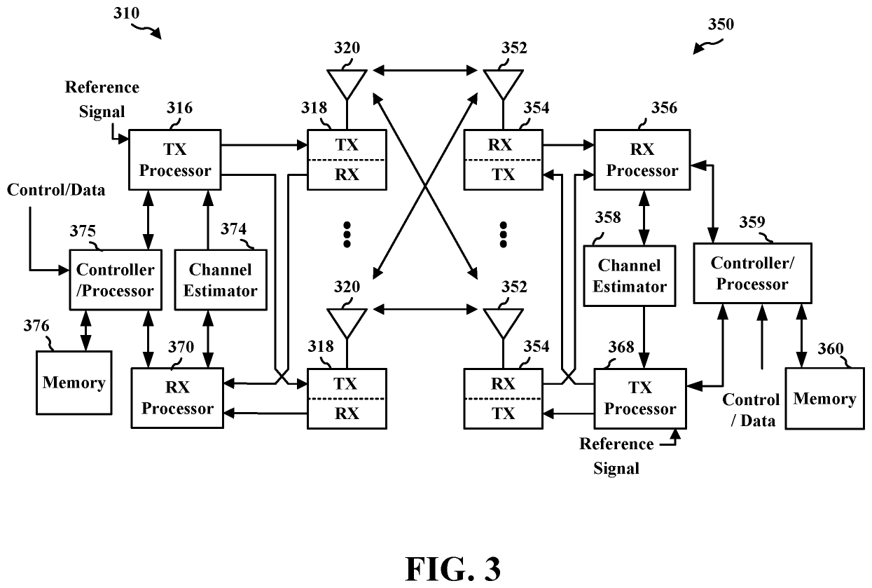

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. At least one of the TX processor 316, the RX processor 370, and the controller/processor 375 may be configured to perform aspects in connection with 199 of FIG. 1.

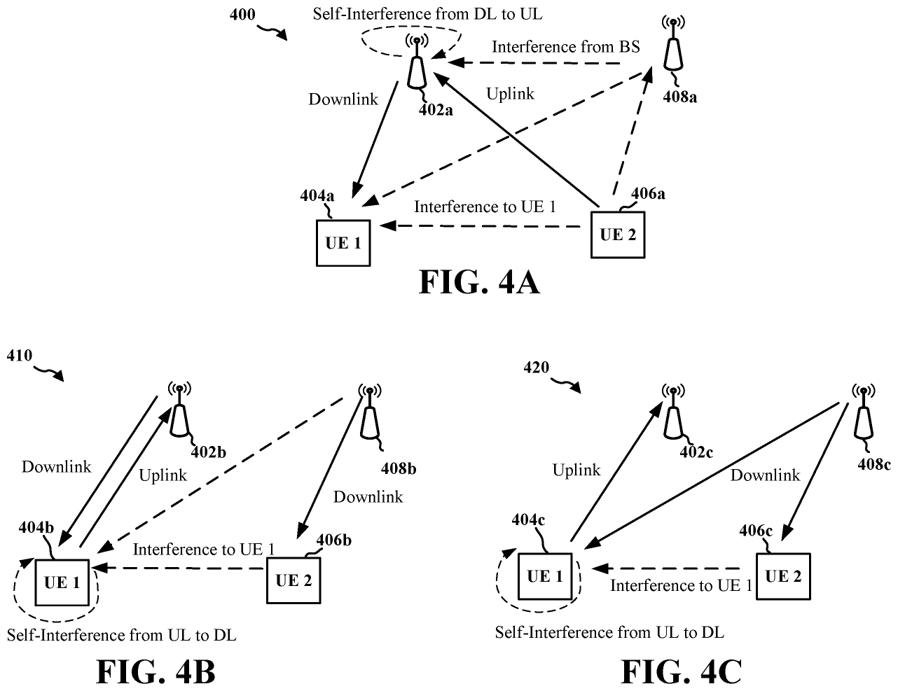

FIGS. 4A-4C illustrate various modes of full-duplex communication. Full-duplex communication supports transmission and reception of information over a same frequency band in manner that overlap in time. In this manner, spectral efficiency may be improved with respect to the spectral efficiency of half-duplex communication, which supports transmission or reception of information in one direction at a time without overlapping uplink and downlink communication. Due to the simultaneous Tx/Rx nature of full-duplex communication, a UE or a base station may experience self-interference caused by signal leakage from its local transmitter to its local receiver. In addition, the UE or base station may also experience interference from other devices, such as transmissions from a second UE or a second base station. Such interference (e.g., self-interference or interference caused by other devices) may impact the quality of the communication, or even lead to a loss of information.

FIG. 4A shows a first example of full-duplex communication 400 in which a first base station 402a is in full-duplex communication with a first UE 404a and a second UE 406a. The first base station 402a is a full-duplex base station, whereas the first UE 404a and the second UE 406a may be configured as either a half-duplex UE or a full-duplex UE. The second UE 406a may transmit a first uplink signal to the first base station 402a as well as to other base stations, such as a second base station 408a in proximity to the second UE 406a. The first base station 402a transmits a downlink signal to the first UE 404a concurrently with receiving the uplink signal from the second UE 406a. The base station 402a may experience self-interference from the receiving antenna that is receiving the uplink signal from UE 406a receiving some of the downlink signal being transmitted to the UE 404a. The base station 402a may experience additional interference due to signals from the second base station 408a. Interference may also occur at the first UE 404a based on signals from the second base station 408a as well as from uplink signals from the second UE 406a.

FIG. 4B shows a second example of full-duplex communication 410 in which a first base station 402b is in full-duplex communication with a first UE 404b. In this example, the first base station 402b is a full-duplex base station and the first UE 404b is a full-duplex UE. The first base station 402b and the UE 404b that can concurrently receive and transmit communication that overlaps in time in a same frequency band. The base station and the UE may each experience self-interference, in which a transmitted signal from the device is leaked to a receiver at the same device. The first UE 404b may experience additional interference based on one or more signals emitted from a second UE 406b and/or a second base station 408b in proximity to the first UE 404b.

FIG. 4C shows a third example of full-duplex communication 420 in which a first UE 404c is a full-duplex UE in communication with a first base station 402c and a second base station 408c. The first base station 402c and the second base station 408c may serve as multiple transmission and reception points (multi-TRPs) for UL and DL communication with the UE 404c. The second base station 408c may be in communication with a second UE 406c. In FIG. 4C, the first UE 404c may concurrently transmit an uplink signal to the first base station 402c while receiving a downlink signal from the second base station 408c. The first UE 404c may experience self-interference as a result of the first signal and the second signal being communicated simultaneously, e.g., the uplink signal may leak to, e.g., be received by, the UE's receiver. The first UE 404c may experience additional interference from the second UE 406c.

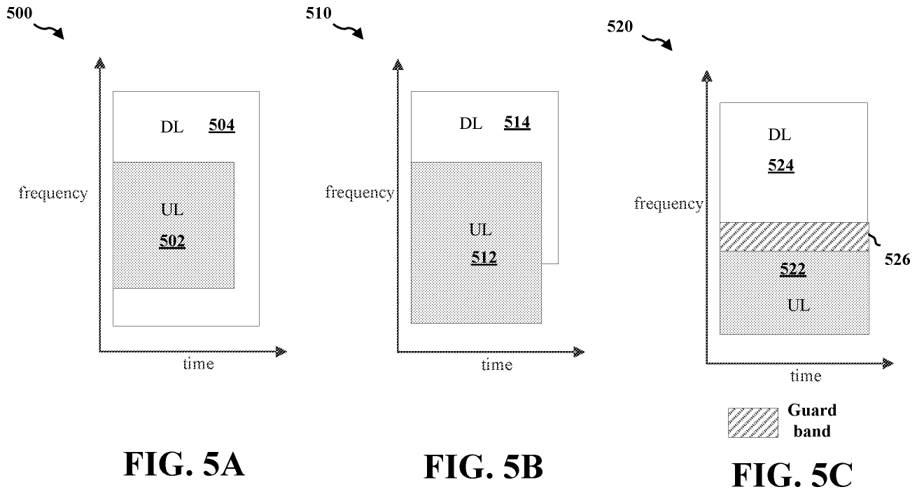

FIGS. 5A-5B illustrate a first example 500 and a second example 510 of in-band full-duplex (IBFD) resources. FIG. 5C illustrates an example 520 of sub-band full-duplex resources. In IBFD, signals may be transmitted and received in overlapping times and overlapping in frequency. As shown in the first example 500, a time and a frequency allocation of a UL resources 502 may fully overlap with a time and a frequency allocation of DL resources 504. In the second example 510, a time and a frequency allocation of UL resources 512 may partially overlap with a time and a frequency of allocation of DL resources 514.

IBFD is in contrast to sub-band FD (SBFD), where uplink and downlink resources may overlap in time using different frequencies, as shown in FIG. 5C. As shown in FIG. 5C, the UL resources 522 are separated from the DL resources 524 by a guard band 526. The guard band may be frequency resources, or a gap in frequency resources, provided between the UL resources 522 and the DL resources 524. Separating the UL frequency resources and the DL frequency resources with a guard band may help to reduce self-interference. UL resources and DL resources that are immediately adjacent to each other correspond to a guard bandwidth of 0. As an output signal, e.g., from a UE transmitter may extend outside the UL resources, the guard band may reduce interference experienced by the UE. Sub-band FD may also be referred to as “flexible duplex.”

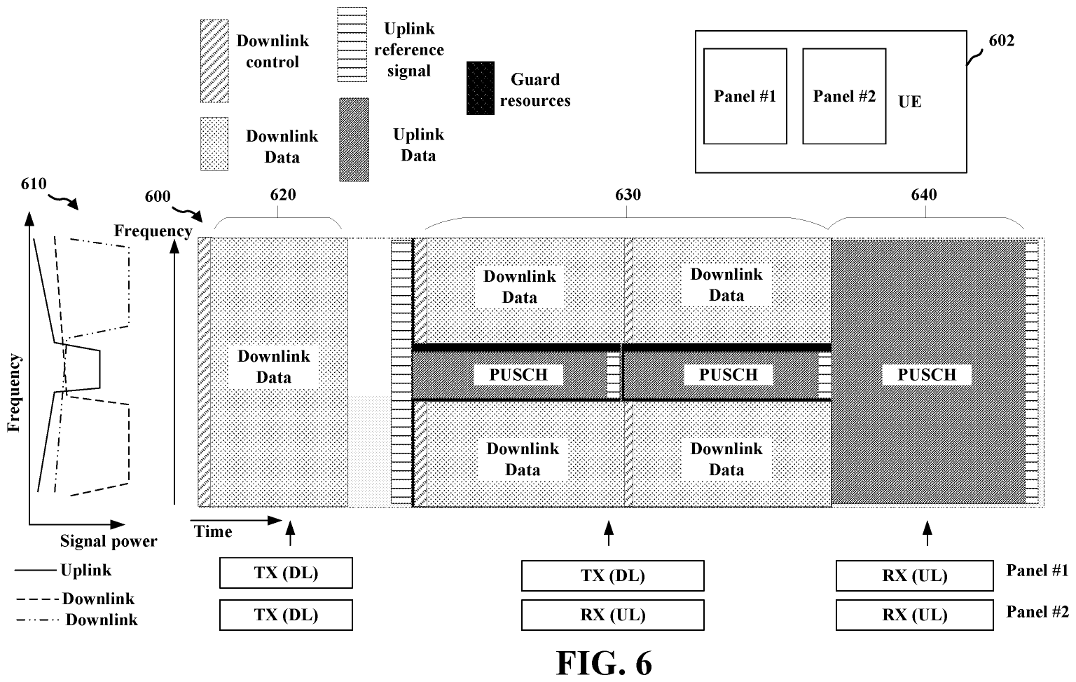

Aspects presented herein help to provide self-interference mitigation. Aspects may help to improve isolation, such as greater than 50 dB. FIG. 6 illustrates an example of device 602 that includes separate panels, e.g., antenna panels, for simultaneous transmission and reception in full-duplex operation. For example, the device 602 is illustrated as including panel #1 and panel #2. In some examples, panel #1 may be for downlink transmission. The downlink transmission may be at both edges of a frequency band, such as illustrated in 600 and 610. Panel #2 may be for uplink reception, such as using frequency resources within a frequency band, such as in the middle of the frequency band. Sub-band full-duplex operation, such as described in connection with FIG. 5C may be associated with an isolation of greater than 40 dB. As shown in FIG. 5C, the downlink and uplink resources may be in different portions of a frequency band with a guard band between the uplink and downlink portions of the frequency band. FIG. 6 illustrates an example set of time and frequency resources 600 that include both half-duplex and full-duplex periods. For example, the period of time 620 includes half-duplex resources for downlink data, e.g., panel #1 and panel #2 may both receive downlink data during the period of time 620. The period of time 620 includes sub-band full-duplex resources for uplink transmissions (e.g., PUSCH) and downlink reception (e.g., downlink data), e.g., panel #1 may receive downlink data, and panel #2 may transmit PUSCH during the period 630. The period of time 640 includes half-duplex resources for uplink data, e.g., panel #1 and panel #2 may both transmit PUSCH during the period of time 640. FIG. 6 also includes a graph 610 showing a signal power over frequency that shows that uplink and downlink signals leak outside of the frequency range provided in the sub-band full-duplex resources of period 630.

A slot format may be referred to as a “D+U” slot when the slot has a frequency band that is used for both uplink and downlink transmissions. The downlink and uplink transmissions may occur in overlapping frequency resources, such as shown in FIGS. 5A and 5B (e.g., in-band full-duplex resources) or may occur in adjacent or slightly separated frequency resources, such as shown in FIG. 5C (e.g., sub-band full-duplex resources). In a particular D+U symbol, a half-duplex device may either transmit in the uplink band or receive in the downlink band. In a particular D+U symbol, a full-duplex device may transmit in the uplink band and receive in the downlink band, e.g., in the same symbol or in the same slot. A D+U slot may include downlink only symbols, uplink only symbols, and full-duplex symbols. For example, in FIG. 6, the period of time 620 may extend for one or more symbols (e.g., downlink only symbols), the period of time 640 may extend for one or more symbols (e.g., uplink only symbols), and the period 630 may extend for one or more symbols (e.g., full-duplex symbols or D+U symbols).

In some examples, the receiver may perform windowed overlap and add (WOLA) to reduce the adjacent channel leakage ratio (ACLR) for the leakage of the uplink signal. An analog low pass filter (LPF) may improve an analog-to-digital conversion (ADC) dynamic range. The receiver automatic gain control (AGC) states may be improved in order to improve the noise figure (NF). Digital interference cancelation of the ACLR leakage, e.g., greater than 20 dB, may be used. In some examples, a non-linear model may be employed for each Tx-Rx pair.

In some examples, uplink power control may be used to mitigate self-interference.

For example, a full-duplex UE may reduce the uplink transmission power, which will reduce the interference caused to downlink reception in full-duplex slots through uplink power control. Similarly, a full-duplex base station may reduce the downlink transmission power to reduce the interference caused to uplink reception in full-duplex slots through downlink power control. In some examples, different uplink power control parameters may be applied for a full-duplex slot that are different than for a half-duplex slot. In some examples, sub-band power control parameters, such as uplink power control offset or scaling, may be applied for full-duplex operation and may be different than parameters applied for half-duplex operation.

Aspects presented herein provide for different power control parameters, e.g., uplink power control parameters per sub-band. Uplink power control parameters per sub-band provide more control and increased flexibility for reducing self-interference, while also protecting the uplink transmission.

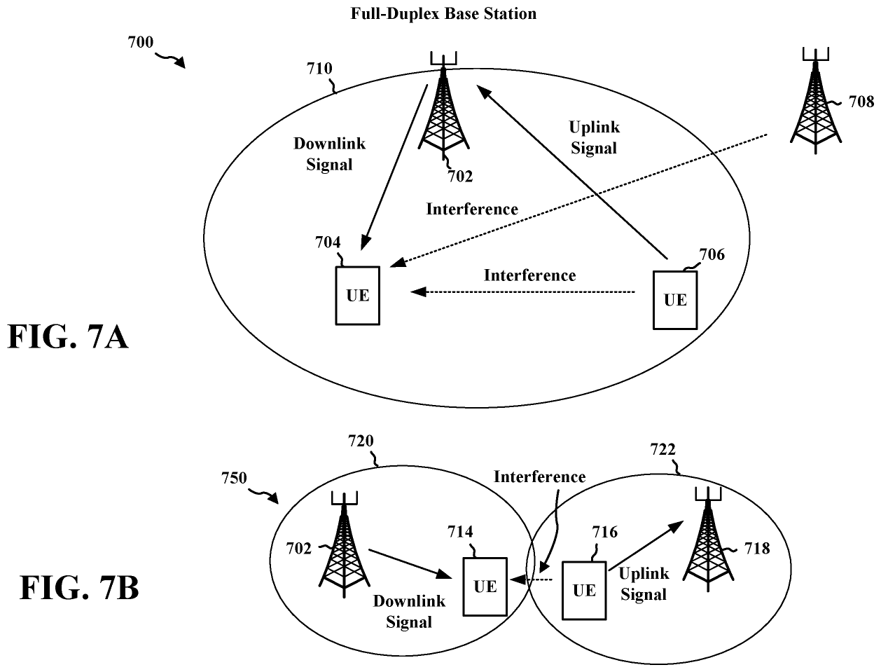

FIG. 7A illustrates an example communication system 700 with a full-duplex base station 702 that includes intra-cell cross-link interference (CLI) caused to UE 704 by UE 706 that are located within the same cell coverage 710 as well as inter-cell interference from a base station 708 outside of the cell coverage 710. FIG. 7B illustrates an example communication system 750 showing inter-cell cross-link interference from UE 716 that interferences with downlink reception for UE 714. The UE 714 is in the cell coverage 720 of base station 712, and the UE 716 is in the cell coverage 722 of the base station 718. Although not shown, a full-duplex UE may cause self-interference to its own downlink reception.

In sub-band full-duplex (SBFD), a base station may configure a downlink transmission to a UE in frequency domain resources that are adjacent to frequency domain resources for uplink transmissions for another UE. For example, in FIG. 7A, the frequency resources for the downlink transmission to the UE 704 may be adjacent to the frequency resources for the uplink transmission from the UE 706.

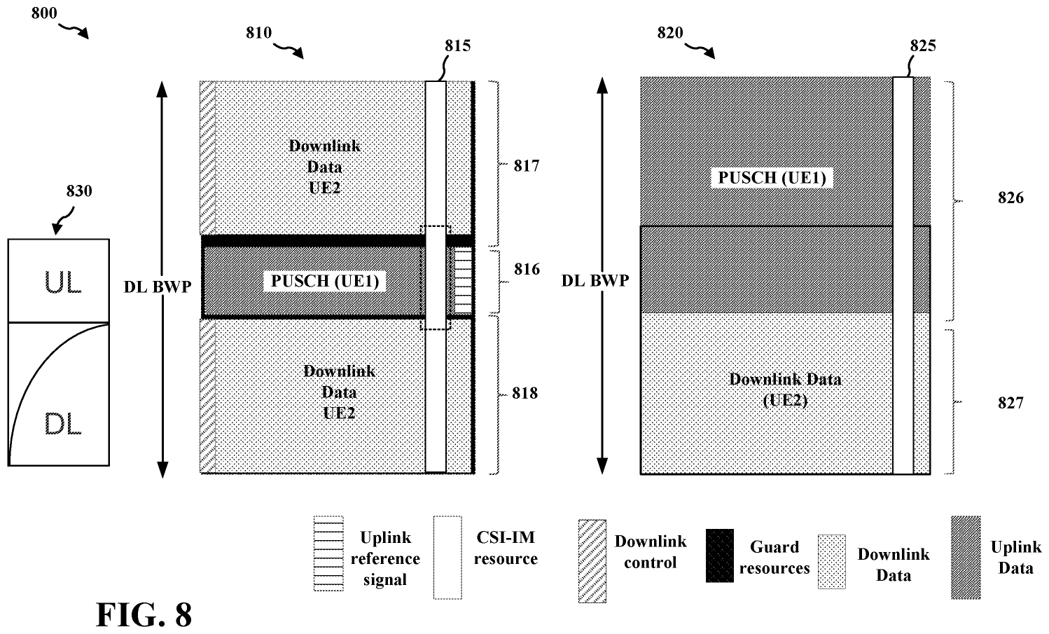

FIG. 8 illustrates examples of CSI-IM resources 800 relative to full-duplex resources of wireless communication. The intra-cell CLI can limit the performance of UEs, e.g., CLI from UL transmissions of nearby users in IBFD or CLI leakage to DL from UL transmissions in SBFD mode. In SBFD and/or IBFD modes, the base station can configure the CSI-IM in both of the UL and DL (whole DL BWP) in a full-duplex slot to enable an FD-aware and/or FD UE to measure different components of interference. That is, the base station may configure the CSI-IM in the whole DL BWP in a full-duplex slot, and instruct the UEs to configure the CSI-IM in the UL channel, to measure different components of interference.

In the SBFD example 810, the CSI-IM resources 815 includes portions 817 and 818 that may be subject to inter-cell interference and CLI leakage, and portion 816 that may mainly include CLI interference. The IBFD example 820 includes CSI-IM resources 825 having a portion 826 that is subject to CLI and a portion 827 that is subject to inter-cell interference and CLI leakage. Intra-cell CLI may limit the performance of some UEs. As described in connection with FIGS. 4A, 4B, 4C, and 7A, the CLI may be from uplink transmissions of nearby users in an IBFD mode or due to CLI leakage to downlink reception in an SBFD mode. For full-duplex communication, a base station may configure CSI-IM resources to extend in both the uplink and downlink portions of DL BWP in a full-duplex slot. The CSI-IM resources may enable a full-duplex aware UE2 or a full-duplex capable UE2 to measure different components of interference. The UE2 may measure interference levels in the configured CSI-IM resources, e.g., 815 or 825. The UE2 may calculate the contribution of CLI, e.g., based on a wideband or sub-band received signal strength indication (RSSI). For example, graph 830 showing the CLI leakage over frequency measured by the UE2 illustrates that the signal power of the CLI leakage is the strongest near the uplink channel transmitted by the UE1.

Here, the UE2 may be a victim UE, and the UE2 may be configured to measure the CLI based on an uplink reference signal of nearby aggressor UEs including the UE1, e.g., such as based on an SRS transmission. That is, the base station may configure the aggressor UE1 with SRS transmission in the UL portion, and the victim UE2 with CSI-IM resources. That is, the victim UE2 may detect the SRS in the CSI-IM overlapping with the CSI-IM resources. Accordingly, the base station may configure the CSI-IM to match the SRS allocation in the UL of the aggressor UE1. Accordingly, the victim UE may measure the CLI in the configured CSI-IM resources, e.g., RSSI, in the portion 816, 817, 818, 826 and 827, and measure a reference signal received power (RSRP) and/or a reference signal received quality (RSRQ) in sub-band corresponding to SRS transmission in the portion 816 and 826.

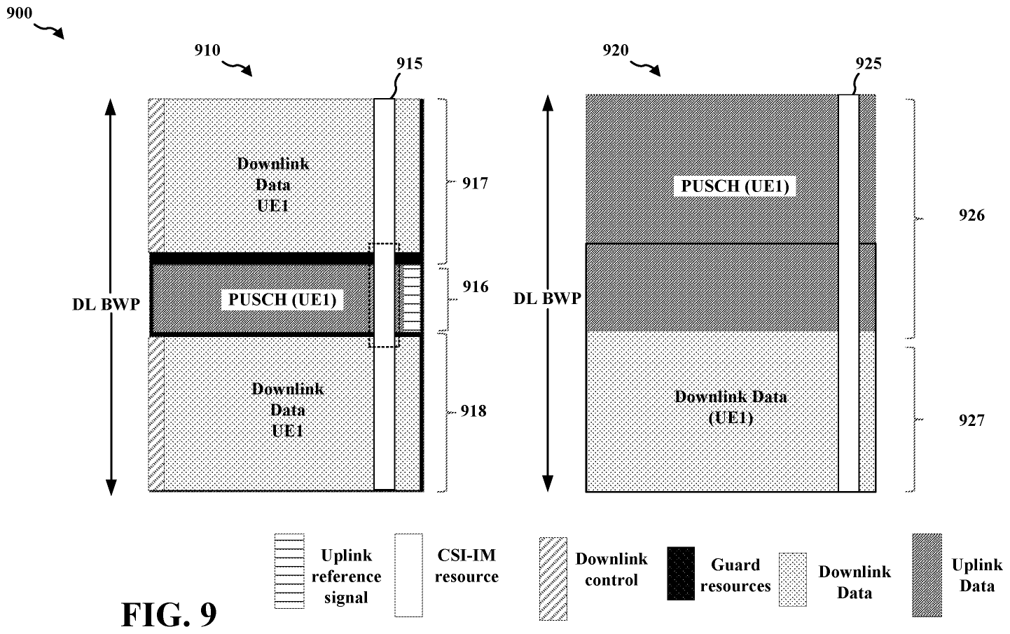

FIG. 9 illustrates examples of CSI-IM resources 900 relative to full-duplex resources of wireless communication. The intra-UE CLI or self-interference can limit the performance of full-duplex UEs. In SBFD and/or IBFD mode, the base station can configure an FD-UE with CSI-IM resources for self-interference measurement. The UE measures interference power in configured CSI-IM resources and calculates the wideband/sub-band self-interference, e.g., RSSI. The base station may also configure the FD-UE with the SRS in UL portion and CSI-IM resources that matches the SRS allocation in SRS BW. The UE calculates self-interference, e.g., RSSI, RSRP, RSRQ, based on SRS.

In the SBFD example 910, the CSI-IM resources 915 includes portions 917 and 918 that may be subject to self-interference from the CLI leakage and portion 916 that may mainly include CLI of self-interference. The IBFD example 920 includes CSI-IM resources 925 having a portion 926 that is subject to CLI of self-interference and a portion 927 that is subject to self-interference from the CLI leakage. The self-interference may limit the performance of the FD UE1. As described in connection with FIGS. 4A, 4B, 4C, and 7A, the self-interference may be from the uplink transmission of the UE1 in the IBFD mode or due to CLI leakage to downlink reception from the uplink transmission of the UE1 in the SBFD mode. For full-duplex communication, a base station may configure CSI-IM resources to extend in both the uplink and downlink portions of DL BWP in a full-duplex slot. The CSI-IM resources may enable a full-duplex UE1 to measure different components of interference. The UE1 may measure interference levels in the configured CSI-IM resources, e.g., 915 or 925. The UE1 may calculate the contribution of self-interference, e.g., based on a wideband or sub-band received signal strength indication (RSSI).

Here, the UE1 may be configured to measure the self-interference based on an uplink reference signal of the UE1, e.g., such as based on an SRS transmission. That is, the base station may configure the FD UE1 with SRS transmission in the UL portion and the UE1 with CSI-IM resources. That is, the FD UE1 may detect the SRS in the CSI-IM overlapping with the CSI-IM resources. The base station may configure the CSI-IM match the SRS allocation in the UL of the FD UE1. Accordingly, the FD UE1 may measure the CLI in the configured CSI-IM resources, e.g., RSSI, in the portion 916, 917, 918, 926, and 927, and measure RSRP and/or the RSRQ in sub-band corresponding to SRS transmission in the portion 916 and 926.

The CLI/SI reporting may be based on short term L1-reporting to help base station make scheduling decisions based on the measured interference. For a dynamic system or a time-varying system, the CLI/SI reporting based on the L1-reporting may improve the accuracy of the base station's scheduling decisions. However, the L1-reporting based CLI/SI reporting may also have an increased reporting overhead.

In some aspects, the base station may configure the UE to semi-periodically report the CLI/SI, or to report an average of the CLI/SI. For example, the UL traffic models may have a periodic pattern, and in turn, the Victim UE may have CLI/SI with a periodic pattern. For another example, the CLI/SI may be almost constant or slow varying for N slots. The base station may be interested in average interference characteristics. In such cases, the base station may determine to configure the UE to report semi-static CLI/SI reports or the average CLI/SI report to reduce reporting overhead and obtain accurate semi-static interference measurements. For example, the base station may configure a victim UE to report the CLI via UL MAC-CE (L2-reporting), and the reported CLI/SI may be measured based on semi-persistent or periodic CSI-IM resources.

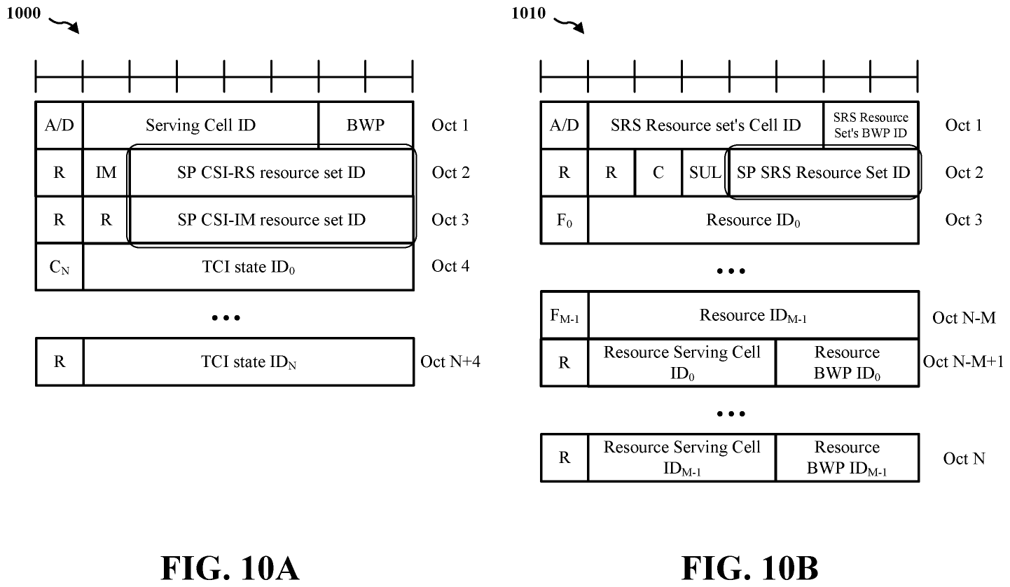

FIGS. 10A and 10B are MAC-CEs 1000 and 1010 for activating the SP CSI-IM resources and SP SRS Resources. First, FIG. 10A illustrates a MAC-CE 1000 for activating the SP CSI-IM resources. The MAC-CE 1000 may be the MAC-CE for SP CSI-IM activation/deactivation, which is transmitted on PDSCH from the base station to the UE. That is, the base station may transmit the SP CSI-IM to activate/deactivate the CSI-IM resources in the downlink transmission to measure the CLI and/or SI. For example, the same MAC-CE may activate/deactivate both the SP CSI-RS for the channel measurements and the CSI-IM for the interference measurements. The activation/deactivation may be on a resource set level. The MAC-CE 1000 may have a variable size bitmap, including an SP CSI-IM resource set ID, an IM field, a TCI state list. The SP CSI-IM resource set ID field may contain an index of a resource set (e.g., CSI-IM-ResourceSet) containing SP CSI-IM resources, indicating the SP CSI-IM resource set, which may activate or deactivate the corresponding SP CSI-IM resources for interference measurements. The length of the field may be 6 bits. The IM field may indicate whether the SP CSI-IM field is present or not, and the TCI state list may indicate the information related to reception beam management for receiving the resources in the associated SP CSI-RS resource set.

FIG. 10B illustrates a MAC-CE 1010 for activating the SPS SRS. The MAC-CE 1010 may be used to activate/deactivate the SP SRS. The MAC-CE 1010 may be the MAC-CE for SP CSI-IM activation/deactivation, which is transmitted on PDSCH from the base station to the UE and/or an aggressor UE. That is, the base station may transmit a MAC-CE to the UE and/or the aggressor UE to activate/deactivate the configured SP SRS in the uplink transmission. The activation/deactivation may be on a resource set level. The MAC-CE 1000 may have a variable size bitmap, including an SP SRS resource set ID and a resource ID list. The SP SRS Resource Set ID may indicate the SP SRS Resource Set ID identified by a corresponding field (e.g., SRS-ResourceSetId), which is to be activated or deactivated. The length of the field may be 4 bits. The Resource ID list may indicate the information related to transmission beam management for transmitting the resources in the associated SP SRS resource set and how to formulate the beam.

In some aspects, the base station may configure an aggressor UE with the SP/periodic (P) (SP/P) SRS resource set. The SP SRS may be activated\deactivated via the MAC-CE. The base station may define a new field in MAC-CE to indicate that the SRS is for CLI measurement and that the SRS should be transmitted with a pre-defined Tx power, e.g., max power P_cmax. Since the interference is dependent on the channel between the UE and the aggressor UE and the transmission power of the uplink from the aggressor UE, the CLI measurement may represent the interferences based on the channel between the UE and the aggressor UE. The base station may configure a victim UE with SP CSI-IM resources. The SP CSI-IM resource set may be activated\deactivated via MAC-CE. In one aspect, the base station may use the same MAC-CE for both the CSI framework and the CLI framework. That is, the same MAC-CE may activate/deactivate both the SP CSI-RS resources and the SP CSI-IM resources. In another aspect, the base station may configure a new MAC-CE for triggering the SP CSI-IM, but not the SP CSI-RS. The MAC-CE may also include the TCI state list for associated CSI-IM resource set. That is, the TCI state list may include TCI states for multiple SP CSI-IM resources, respectively. In one aspect, if a UE is both victim and aggressor for SI measurement, the base station may define a new MAC-CE for triggering both SP SRS and SP CSI-IM for CLI/SI measurement.

In some aspects, the base station may configure the victim UE with SP/P CSI-IM resource sets to measure the CLI and/or SI. The victim UE may report one or more CLI values or measurements via an uplink MAC-CE, based on triggering events. The base station may define triggering events for CLI reporting when the UE is configured with P/SP CSI-IM resources. The triggering events may include, but not limited to, the measured interference exceeding a certain threshold, a change in the CLI by a certain factor at the expiration of a timer, a periodic timer, and/or deactivation of the SP CSI-IM resource set for the CLI measurement. That is, the UE may report the CLI if the measured interference exceeds a certain threshold if a timer has expired and the CLI changed by a certain factor, based on the periodic timer, and/or when the SP CSI-IM set used for the CLI measurement is deactivated. The uplink MAC-CE used for CLI reporting may contain one or more CLI value field (6 bits) and the associated one or more CSI-IM-ResourceSet ID (6 bits) used for CLI measurement. For each CSI-IM resource in the resource set, the UE may report one or more subband CLI value.

In some aspects, the base station may provide a joint MAC-CE for triggering the SP CSI-IM resources and the CLI reporting. The MAC-CE triggering the SP CSI-IM resources may also trigger the victim UE to send CLI/SI reports associated with the CSI-IM resource set to the base station. For example, the MAC-CE activating the SP CSI-IM resources may trigger SP CLI reporting based on the triggered SP CSI-IM resources. The CLI reporting may be sent via the PUCCH (L1-reporting) or via the UL MAC-CE (L2-reporting). For another example, a MAC-CE deactivating the SP CSI-IM may trigger the CLI reporting using UL MAC-CE. In this case, the UE may report the average CLI.

In some aspects, the base station may indicate the UE to report the most recent CLI measurements or an average of the CLI measurements. That is, the base station may define a field (e.g., timeRestrictionForInterferenceMeasurements) in the CLI report while RRC configuration to indicate whether the UE may report the most recent CLI measurement or the average (filtered) CLI over measurement occasion when configured with SP/P CSI-IM resources. For example, if the defined field is configured (e.g., timeRestrictionForInterferenceMeasurements=configured), the UE may report the most recent CLI measurement. For another example, if the defined field is not configured (e.g., timeRestrictionForInterferenceMeasurements=notConfigured), the UE may report the average CLI.

In some aspects, the UE may indicate, to the base station, whether the UE has the capability related to the SP CLI reporting and the activation of the SP CLI reporting. The capabilities of the UE related to the SP CLI reporting may include a capability to support the new MAC-CE (e.g., MAC-CE 1010) for configuring SRS with max power, a capability to support new MAC-CE for triggering only SP CSI-IM, a capability to use different QCL-D for SP CSI-IM measurement occasion, a capability to support new MAC-CE for triggering both of the SP SRS and the SP CSI-IM, a capability to support the L2 CLI reporting, a capability to support the joint MAC-CE for triggering SP CSI-IM and CLI reporting, and a capability to support CLI reciprocity approach. The UE may indicate the capabilities of the UE related to the SP CLI reporting while configuring the RRC.

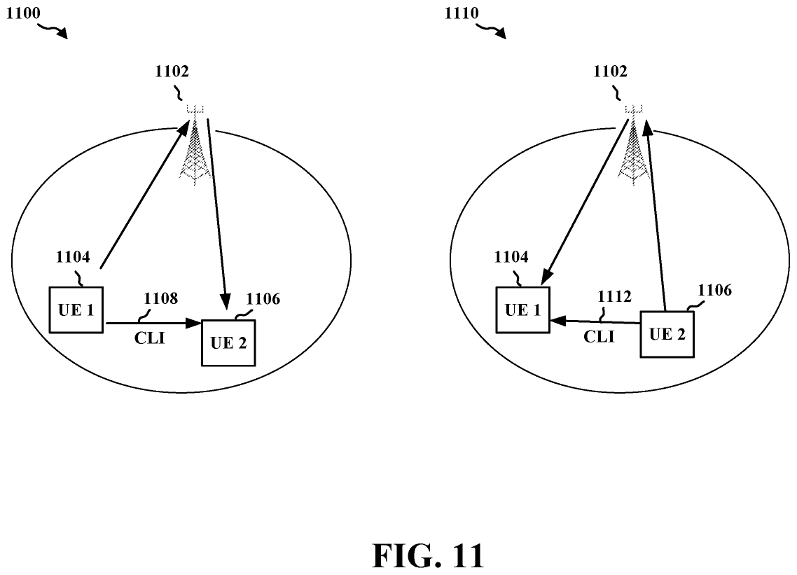

FIG. 11 illustrates a CLI reciprocity between two UEs. The CLI measured by the victim UE may be a function of transmission power and a coupling loss (CL). If the CL is known, UE and the base station may estimate CLI for different Tx powers. 1110 illustrates that the base station 1102 may configure the UE11 1104 with the SRS or the PUSCH transmission over multiple slots to the base station 1102. The base station 1102 may configure the UE2 1106 with the SP/P CSI-IM resources to measure the CLI 1108 over these slots based on the SRS or the PUSCH transmission. The base station 1102 may inform the victim UE2 1106 with an average transmission power of the UE11 1104 in the CLI measuring occasions. The victim UE2 1106 may estimate an average CL from the measurements of the CLI 1108 and the average transmission power of the aggressors UE1 1104. The victim UE2 1106 may report the average CL and/or the CLI measurements to the base station 1102. The base station 1102 may use the estimated average CL reported from the UE1 1104 to estimate the CLI in the opposite direction from the UE2 1106 to the UE1 1104. 1110 illustrates that the base station 1102 may check the CLI reciprocity by configuring the UE1 1104 to estimate and report the CL based on the CLI 1112 with the UE2 1106. The base station 1102 may check the CLI reciprocity by comparing the estimated CL reported from the UE2 1106, and the estimated CL reported from the UE1 1104.

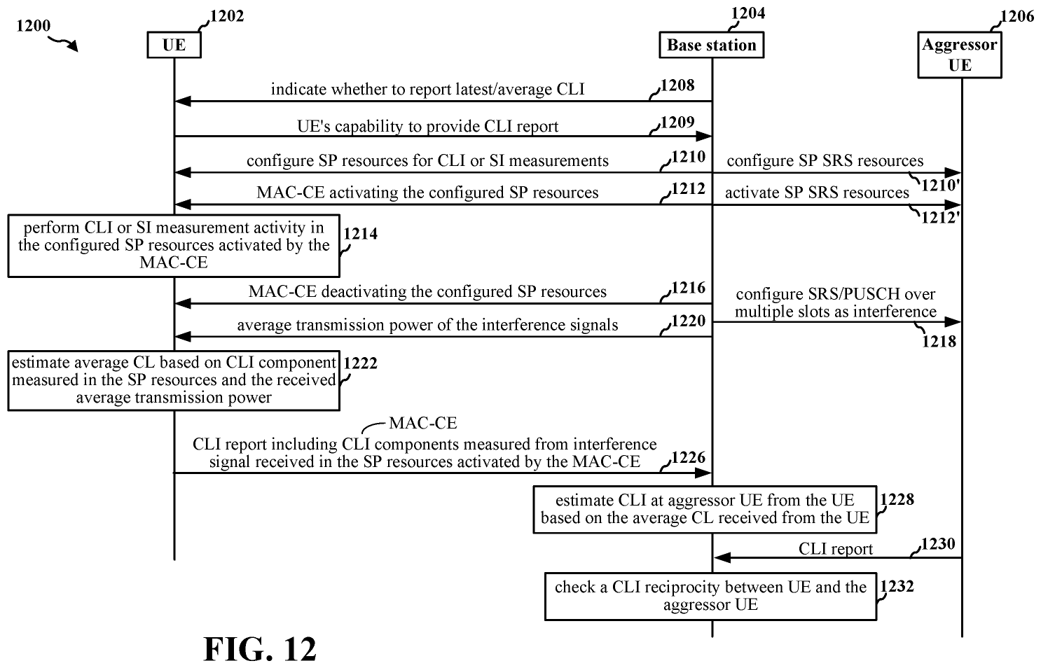

FIG. 12 illustrates a call-flow diagram 1200 of wireless communication. The call-flow diagram 120 may include a UE 1202 (e.g., UE2 1106), a base station 1204 (e.g., base station 1102), and an aggressor UE 1206 (e.g., UE1 1104). The base station 1204 may configure SP resources for the UE 1202 to perform a CLI measurement, and the UE 1202 may report a CLI report including CLI components indicating the CLI values or measurements from the interference signal received in the SP resources.

At 1208, the base station 1204 may transmit an RRC messaging including a CLI report configuration that indicates for the UE 1202 to report one of the most recent CLI measurements or a filtered CLI value over all the CLI measurements in the CLI report when the first MAC-CE configures the UE 1202 with P or SP CSI-IM resources. That is, the base station 1204 may indicate the UE 1202 to report the most recent CLI measurements or an average of the CLI measurements. At 1209, the UE 1202 may indicate whether the UE 1202 has the capability related to the SP CLI reporting and the activation of the SP CLI reporting. The indication at 1208 and 1209 may be RRC messages communicated during the configuring the RRC connection between the UE 1202 and the base station 1204.

At 1210, the base station 1204 may configure the UE 1202 with SP CSI-IM resources for CLI and/or SI measurements. The UE 1202 may receive, from the base station 1204, the configuration of at least one SP CLI or SI measurement. In one aspect, the configuration from the base station 1204 may include a set of configurations of the at least one SP CLI or SI measurement. The base station 1204 may activate (or select) at least one configuration from the set of configurations of the at least one SP CLI or SI measurement. The base station 1204 may transmit the configuration via the RRC messages transmitted from the base station 1204 to the UE 1202.

At 1210′ the base station 1204 may also configure the aggressor UE 1206 with SP SRS resources. In one aspect, the configuration from the base station 1204 may include a set of configurations of the at least one SP CLI or SI measurement. The base station 1204 may activate (or select) at least one configuration from the set of configurations of the at least one SP CLI or SI measurement. The base station 1204 may transmit the configuration via the RRC messages transmitted from the base station 1204 to the aggressor UE 1206.

At 1212, the base station 1204 may transmit a MAC-CE to the UE 1202, activating the SP resources for CLI and/or SI measurements configured at 1210. The UE 1202 may receive, from the base station 1204, the MAC-CE activating the SP resources for CLI and/or SI measurements as configured at 1210. That is, the base station 1204 may configure a set of configurations of the at least one SP CLI or SI measurement at 1210, and activate (or select) at least one configuration from the set of configurations of the at least one SP CLI or SI measurement. The base station 1204 may transmit the MAC-CE activating the SP CSI-IM resources to also trigger the CLI reporting. For example, the MAC-CE activating the SP CSI-IM resources may also trigger the SP CLI reporting based on the triggered SP CSI-IM resources.

At 1212′, the base station 1204 may also transmit MAC-CE to the aggressor UE 1206 to activate the SP SRS resources configured at 1210′. The aggressor UE 1206 may receive, from the base station 1204, the MAC-CE activating the SP resources for CLI and/or SI measurements configured at 1210. That is, the base station 1204 may configure a set of configurations of the at least one SP CLI or SI measurement at 1210, and activate (or select) at least one configuration from the set of configurations of the at least one SP CLI or SI measurement. The base station 1204 may transmit the MAC-CE activating the SP CSI-IM resources to also trigger the CLI reporting. For example, the MAC-CE activating the SP CSI-IM resources may also trigger the SP CLI reporting based on the triggered SP CSI-IM resources.

At 1214, the UE 1202 may perform the CLI and/or SI measurement activity in the configured SP resource activated by the MAC-CE. That is, the UE 1202 may measure the CLI components and SI components of the CLI report by the interference from the uplink transmission of the aggressor UE 1206 (e.g., the CLI components) or the interference from the uplink transmission of the UE 1202 (e.g., the SI components).

At 1216, the base station 1204 may transmit a MAC-CE deactivating the configured SP resources, which were activated at 1212. The UE 1202 may receive the MAC-CE to deactivate the SP resource, wherein the second MAC-CE triggers a CLI report. The UE 1202 may receive the MAC-CE deactivating the configured SP resources, stop performing the CLI and/or SI measurements in the SP SRS resources and reporting the CLI report.

At 1218, the base station 1204 may configure the aggressor UE 1206 with the SRS or the PUSCH transmission over multiple slots to the base station 1204. At 1220, the base station 1204 may inform the UE 1202 with an average transmission power of the aggressor UE 1206 in the CLI measuring occasions. The UE 1202 receive, from the base station 1204, the average transmission power of the at least one interference signal from an aggressor UE 1206. That is, the UE 1202 may be informed, by the base station 1204, of the average transmission power of the aggressor UE 1206 in the CLI measuring occasions.

At 1222, the UE 1202 may estimate an average CL with the aggressor UE 1206 based on at least one CLI component measured in the SP resources and the received average transmission power. That is, the UE 1202 may estimate the average CL from the CLI measured at 1214, and/or the average transmission power of the aggressors UE 1206 received at 1220.

At 1226, the UE 1202 may report the CLI report or the SI report, including the CLI components indicating the CLI values or measurements or the SI components indicating the SI values or measurements from the interference signal received in the SP resources activated by the MAC-CE. The base station 1204 may receive the CLI report or the SI report, including the CLI components indicating the CLI values or measurements or the SI components indicating the SI values or measurements from the interference signal received in the SP resources activated by the MAC-CE. The CLI report or the SI report may be transmitted to the base station 1204 via an uplink MAC-CE. The CLI report or the SI report may be transmitted in response to triggering events, including the measured interference at 1214 exceeding a certain threshold, a change in the CLI measured at 1214 by a certain factor at the expiration of a timer configured at 1208, a periodic timer configured at 1208, and/or deactivation of the SP CSI-IM resource set for the CLI measurement at 1216. Also, the CLI reporting may include the average CL estimated based on the measurements of the CLI and the average transmission power of the aggressors UE 1206 received at 1220. The CLI reporting and the estimated average CL may be transmitted on the same MAC-CE occasion or different MAC-CE occasions.

At 1228, the base station 1204 may estimate the CLI at the aggressor UE 1206 from the UE 1202 based on the average CL estimated at 1214 and received from the UE 1202 at 1226. That is, the base station 1204 may use the estimated average CL reported from the aggressor UE 1206 to estimate the CLI in the opposite direction from the UE 1202 to the aggressor UE 1206.

At 1230, the base station 1204 may receive a CLI report, including an estimated CL based on the interference with the UE 1202. At 1232, the base station 1204 may check the CLI reciprocity between the UE 1202 and the aggressor UE 1206 based on the estimated CLs reported from the UE 1202 and the aggressor UE 1206. That is, the base station 1204 may check the CLI reciprocity by comparing the estimated CL reported from the UE 1202 at 1226, and the estimated CL reported from the aggressor UE 1206 at 1230.

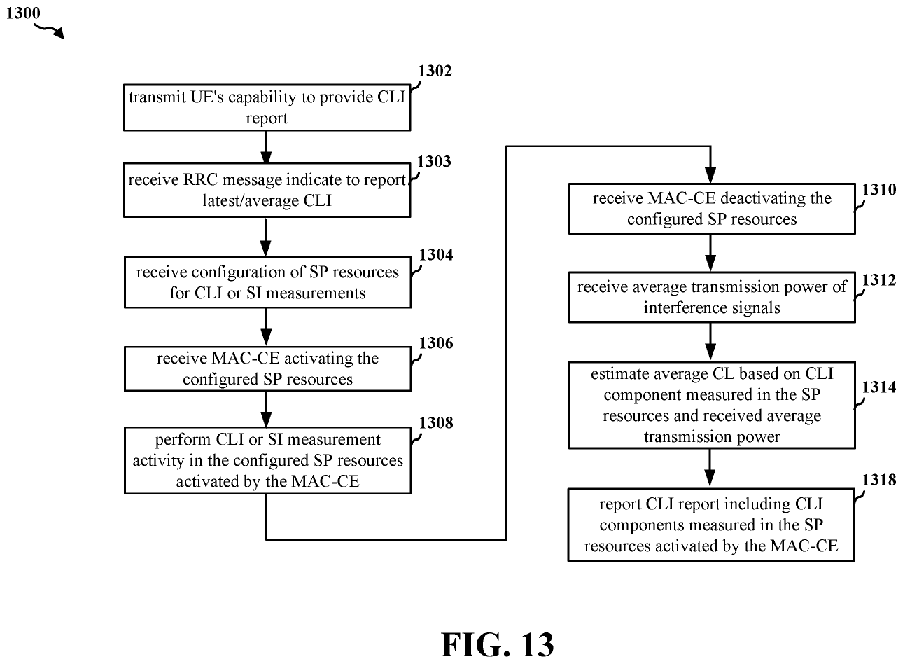

FIG. 13 is a flowchart 1300 of a method of wireless communication. The method may be performed by a UE (e.g., the UE 104; the apparatus 1402). A base station may configure SP resources for the UE to perform a CLI measurement, and the UE may report a CLI report including CLI components indicating the CLI values or measurements from the interference signal received in the SP resources.

At 1302, the UE may receive an indication from the base station to report the most recent CLI measurements or an average of (or filtered) the CLI measurements during the RRC configuration (e.g., as at 1208). The indication may be an RRC message communicated during the configuring the RRC connection between the UE and the base station. For example, at 1208, the UE 1202 may receive the indication from the base station 1204 on whether to report the most recent CLI measurements or an average of the CLI measurements. Furthermore, 1302 may be performed by a CLI report component 1444.

At 1303, the UE may indicate whether the UE has the capability related to the SP CLI and/or SI reporting and the activation of the SP CLI and/or SI reporting (e.g., as at 1209). The UE may indicate whether the UE supports one or more of a MAC-CE activating an SRS for the CLI or SI measurement with a maximum transmission power, the MAC-CE activating an SP CSI-IM for the CLI and/or SI measurements, use of a different QCL D for an SP SI-IM measurement occasion, a MAC-CE activating SP CSI-IM and/or SP SRS resources for the CLI and/or SI measurement, layer 2 (L2) CLI reporting, a joint MAC-CE triggering SP CSI-IM and CLI reporting, or a CLI reciprocity. The indication may be an RRC message communicated during the configuring the RRC connection between the UE and the base station. For example, at 1209, the UE 1202 may transmit the indication to the base station 1204 on whether the UE 1202 has the capability related to the SP CLI reporting and the activation of the SP CLI reporting. Furthermore, 1316 may be performed by the CLI report component 1444.

At 1304, the UE may receive a configuration of one or more SP CSI-IM resources for the CLI and/or SI measurements from the base station (e.g., as at 1210). In one aspect, the configuration from the base station 1204 may include a set of configurations of the at least one SP CLI or SI measurement. The base station 1204 may activate (or select) at least one configuration from the set of configurations of the at least one SP CLI or SI measurement. The base station 1204 may transmit the configuration via the RRC messages transmitted from the base station 1204 to the UE 1202. For example, at 1210, the UE 1202 may receive, from the base station 1204, the configuration of at least one SP CLI or SI measurement. Furthermore, 1304 may be performed by a CSI-IM resources managing component 1440.

At 1306, the UE may receive a MAC-CE from the base station activating the one or more SP resources for the CLI and/or SI measurements configured at 1304 (e.g., as at 1212). That is, the base station may configure a set of configurations of the at least one SP CLI or SI measurement, and activate (or select) at least one configuration from the set of configurations of the at least one SP CLI or SI measurement. The base station may transmit the MAC-CE activating the SP CSI-IM resources to also trigger the CLI reporting. For example, the MAC-CE activating the SP CSI-IM resources may also trigger the SP CLI reporting based on the triggered SP CSI-IM resources. The activating MAC-CE may also indicate a transmission power for the SP SRS resource for the SP SI measurements. The MAC-CE activating the CSI-IM resources may be separate from the activation/deactivation of CSI-RS resources. The activating MAC-CE may also activate the CLI and/or SI report. The CLI and/or SI report activated by the MAC-CE may be transmitted via the PUCCH or the uplink MAC-CE. For example, at 1212, the UE 1202 may receive, from the base station 1204, the MAC-CE activating the SP resources for CLI and/or SI measurements as configured. Furthermore, 1306 may be performed by the CSI-IM resources managing component 1440.

At 1308, the UE may perform the CLI and/or SI measurement activity in the configured one or more SP resources activated by the MAC-CE (e.g., as at 1214). That is, the UE may measure the CLI components and SI components of the CLI report by the interference from the uplink transmission of the aggressor UE (e.g., the CLI components) or the interference from the uplink transmission of the UE (e.g., the SI components). For example, at 1214, the UE 1202 may perform the CLI and/or SI measurement activity in the configured SP resource activated by the MAC-CE. Furthermore, 1308 may be performed by the CLI report component 1444.

At 1310, the UE may receive a MAC-CE deactivating the configured one or more SP resources, which were activated at 1306 (e.g., as at 1216). The UE may receive the MAC-CE deactivating the configured SP resources, stop performing the CLI and/or SI measurements in the SP SRS resources and reporting the CLI report. The deactivating MAC-CE may also activate the CLI and/or SI report. The CLI and/or SI report activated by the deactivating MAC-CE may be transmitted via the uplink MAC-CE, and the CLI and/or SI report may include an average CLI. For example, at 1216, the UE 1202 may receive the MAC-CE to deactivate the SP resource, wherein the second MAC-CE triggers a CLI report. Furthermore, 1310 may be performed by the CSI-IM resources managing component 1440.

At 1312, the UE may receive, from the base station 1204, an average transmission power of the at least one interference signal from an aggressor UE. That is, the UE may receive the average transmission power of the aggressor UE in the CLI measuring occasions (e.g., as at 1220). For example, at 1220, the UE 1202 may receive, from the base station 1204, the average transmission power of the at least one interference signal from an aggressor UE 1206. Furthermore, 1312 may be performed by the CLI report component 1444.

At 1314, the UE may estimate an average CL with the aggressor UE 1206 based on at least one CLI component measured in the SP resources and the received average transmission power. That is, the UE may estimate an average CL from the CLI measured at 1308 and the average transmission power of the aggressors UE received at 1312 (e.g., as at 1222). For example, at 1222, the UE 1202 may estimate an average CL with the aggressor UE 1206 based on at least one CLI component measured in the SP resources and the received average transmission power. Furthermore, 1314 may be performed by an interference measurement component 1442.

At 1318, the UE may report a CLI report, including CLI components indicating the CLI values or measurements from the interference signal received in the SP resources activated by the MAC-CE (e.g., as at 1226). The CLI report may be transmitted via the uplink MAC-CE. The CLI report may be transmitted in response to triggering events, including the measured interference at 1308 exceeding a certain threshold, a change in the CLI measured at 1308 by a certain factor at the expiration of a timer configured at 1302, a periodic timer configured at 1302, and/or deactivation of the SP CSI-IM resource set for the CLI measurement received at 1310. Also, the CLI reporting may include the average CL estimated based on the measurements of the CLI and the average transmission power of the aggressors UE received at 1312. The CLI reporting and the estimated average CL may be transmitted on different MAC-CE occasions. For example, at 1226, the UE 1202 may report the CLI report, including the CLI components indicating the CLI values or measurements from the interference signal received in the SP resources activated by the MAC-CE. Furthermore, 1318 may be performed by the CLI report component 1444.

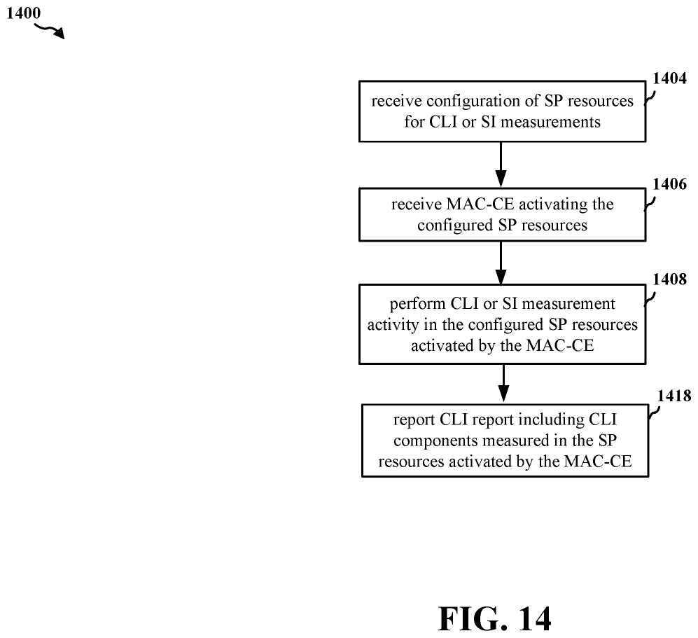

FIG. 14 is a flowchart 1400 of a method of wireless communication. The method may be performed by a UE (e.g., the UE 104; the apparatus 1502). A base station may configure SP resources for the UE to perform a CLI measurement, and the UE may report a CLI report including CLI components indicating the CLI values or measurements from the interference signal received in the SP resources.

At 1404, the UE may receive a configuration of one or more SP CSI-IM resources for the CLI and/or SI measurements from the base station (e.g., as at 1210). In one aspect, the configuration from the base station 1204 may include a set of configurations of the at least one SP CLI or SI measurement. The base station 1204 may activate (or select) at least one configuration from the set of configurations of the at least one SP CLI or SI measurement. The base station 1204 may transmit the configuration via the RRC messages transmitted from the base station 1204 to the UE 1202. For example, at 1210, the UE 1202 may receive, from the base station 1204, the configuration of at least one SP CLI or SI measurement. Furthermore, 1404 may be performed by a CSI-IM resources managing component 1440.

At 1406, the UE may receive a MAC-CE from the base station activating the one or more SP resources for the CLI and/or SI measurements configured at 1404 (e.g., as at 1212). That is, the base station may configure a set of configurations of the at least one SP CLI or SI measurement, and activate (or select) at least one configuration from the set of configurations of the at least one SP CLI or SI measurement. The base station may transmit the MAC-CE activating the SP CSI-IM resources to also trigger the CLI reporting. For example, the MAC-CE activating the SP CSI-IM resources may also trigger the SP CLI reporting based on the triggered SP CSI-IM resources. The activating MAC-CE may also indicate a transmission power for the SP SRS resource for the SP SI measurements. The MAC-CE activating the CSI-IM resources may be separate from the activation/deactivation of CSI-RS resources. The activating MAC-CE may also activate the CLI and/or SI report. The CLI and/or SI report activated by the MAC-CE may be transmitted via the PUCCH or the uplink MAC-CE. For example, at 1212, the UE 1202 may receive, from the base station 1204, the MAC-CE activating the SP resources for CLI and/or SI measurements as configured. Furthermore, 1406 may be performed by the CSI-IM resources managing component 1440.

At 1408, the UE may perform the CLI and/or SI measurement activity in the configured one or more SP resources activated by the MAC-CE (e.g., as at 1214). That is, the UE may measure the CLI components and SI components of the CLI report by the interference from the uplink transmission of the aggressor UE (e.g., the CLI components) or the interference from the uplink transmission of the UE (e.g., the SI components). For example, at 1214, the UE 1202 may perform the CLI and/or SI measurement activity in the configured SP resource activated by the MAC-CE. Furthermore, 1408 may be performed by the CLI report component 1444.

At 1418, the UE may report a CLI report, including CLI components indicating the CLI values or measurements from the interference signal received in the SP resources activated by the MAC-CE (e.g., as at 1226). The CLI report may be transmitted via the uplink MAC-CE. The CLI report may be transmitted in response to triggering events, including the measured interference at 1408 exceeding a certain threshold, a change in the CLI measured at 1408 by a certain factor at the expiration of a timer configured at 1402, a periodic timer configured at 1402, and/or deactivation of the SP CSI-IM resource set for the CLI measurement received at 1410. Also, the CLI reporting may include the average CL estimated based on the measurements of the CLI and the average transmission power of the aggressors UE received at 1412. The CLI reporting and the estimated average CL may be transmitted on different MAC-CE occasions. For example, at 1226, the UE 1202 may report the CLI report, including the CLI components indicating the CLI values or measurements from the interference signal received in the SP resources activated by the MAC-CE. Furthermore, 1418 may be performed by the CLI report component 1444.

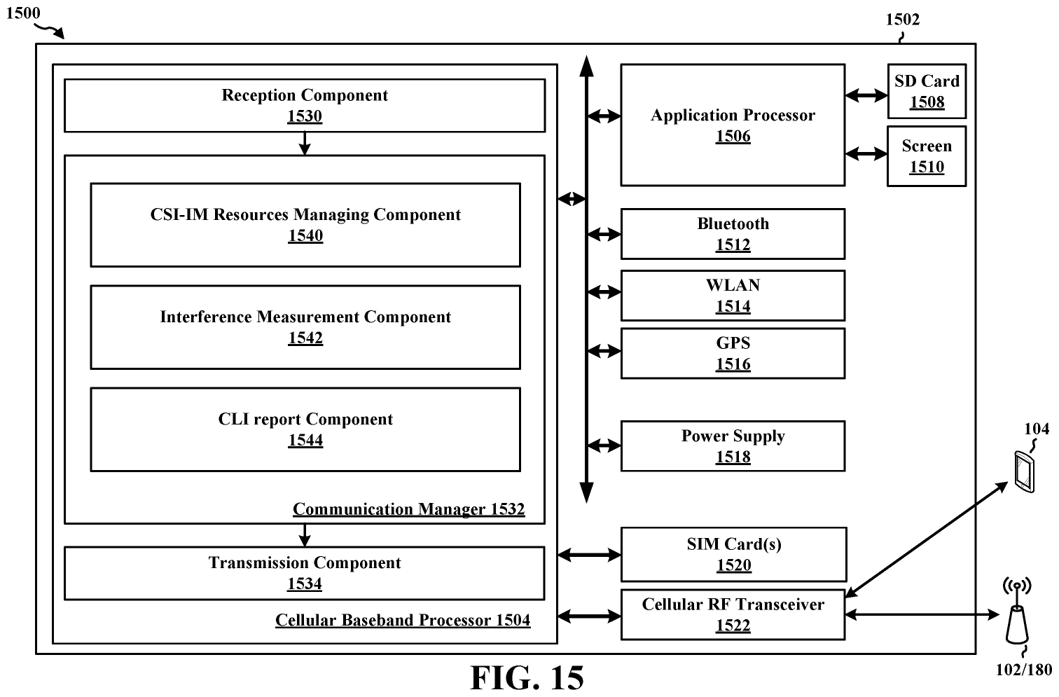

FIG. 15 is a diagram 1500 illustrating an example of a hardware implementation for an apparatus 1502. The apparatus 1502 may be a UE, a component of a UE, or may implement UE functionality. In some aspects, the apparatus 1502 may include a cellular baseband processor 1504 (also referred to as a modem) coupled to a cellular RF transceiver 1522. In some aspects, the apparatus 1502 may further include one or more subscriber identity modules (SIM) cards 1520, an application processor 1506 coupled to a secure digital (SD) card 1508 and a screen 1510, a Bluetooth module 1512, a wireless local area network (WLAN) module 1514, a Global Positioning System (GPS) module 1516, or a power supply 1518. The cellular baseband processor 1504 communicates through the cellular RF transceiver 1522 with the UE 104 and/or the base station 102/180. The cellular baseband processor 1504 may include a computer-readable medium/memory. The computer-readable medium/memory may be non-transitory. The cellular baseband processor 1504 is responsible for general processing, including the execution of software stored on the computer-readable medium/memory. The software, when executed by the cellular baseband processor 1504, causes the cellular baseband processor 1504 to perform the various functions described supra. The computer-readable medium/memory may also be used for storing data that is manipulated by the cellular baseband processor 1504 when executing software. The cellular baseband processor 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the cellular baseband processor 1504. The cellular baseband processor 1504 may be a component of the UE 350 and may include the memory 360 and/or at least one of the TX processor 368, the RX processor 356, and the controller/processor 359. In one configuration, the apparatus 1502 may be a modem chip and include just the baseband processor 1504, and in another configuration, the apparatus 1502 may be the entire UE (e.g., see 350 of FIG. 3) and include the additional modules of the apparatus 1502.

The communication manager 1532 includes a CSI-IM resources managing component 1540 that is configured to receive a configuration of one or more SP CSI-IM resources for the CLI and/or SI measurements, receive a MAC-CE from the base station activating the one or more SP resources for the CLI and/or SI measurements, and receive a MAC-CE deactivating the configured one or more SP resources, e.g., as described in connection with 1304, 1306, 1310, 1404, and 1406. The communication manager 1532 further includes an interference measurement component 1542 that is configured to estimate an average CL from the measured CLI and the average transmission power of the aggressors UE, e.g., as described in connection with 1314. The communication manager 1532 further includes a CLI report component 1544 that is configured to receive an indication from the base station to report the most recent CLI measurements or an average of (or filtered) the CLI measurements during the RRC configuration, indicate the whether the UE has the capability related to the SP CLI and/or SI reporting and the activation of the SP CLI and/or SI reporting, perform the CLI and/or SI measurement activity in the configured one or more SP resources activated by the MAC-CE, receive an average transmission power of the aggressor UE in the CLI measuring occasions, and report a CLI report including CLI components indicating the CLI values or measurements from the interference signal receive in the SP resources activated by the MAC-CE, e.g., as described in connection with 1302, 1303, 1308, 1312, 1318, 1408, and 1418.

The apparatus may include additional components that perform each of the blocks of the algorithm in the flowcharts of FIGS. 12, 13, and 14. As such, each block in the flowcharts of FIGS. 12, 13, and 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the cellular baseband processor 1504, includes means for receiving, from a base station, a configuration of at least one SP resources for a CLI or SI measurement, means for receiving, from the base station, a first MAC-CE activating at least one configured SP resources for the CLI measurement or SI measurement, and means for performing a CLI or SI measurement activity in the at least one configured SP resources activated by the MAC-CE. The apparatus 1502 includes means for receiving an RRC messaging including a CLI report configuration that indicates for the UE to report one of the most recent CLI measurements or a filtered CLI value over all the CLI measurements in the CLI report when the first MAC-CE configures the UE with P or SP CSI-IM resources, and means for reporting, to the base station, a CLI report including at least one CLI component measured from at least one interference signal received in the SP resources activated by the MAC-CE. The apparatus 1502 includes means for receiving a second MAC-CE to deactivate the SP resource, where the second MAC-CE triggers a CLI report, and means for transmitting the CLI report, including an average CLI in an uplink MAC-CE to the base station. The apparatus 1502 includes means for receiving, from the base station, average transmission power of at least one interference signal from an aggressor UE, and means for estimating an average CL with the aggressor UE based on at least one CLI component measured in the SP resources and the received average transmission power. The apparatus 1502 includes means for indicating to the base station, during an RRC configuration, whether the UE supports at least one of the MAC-CE activating a SRS for the CLI or SI measurement with a preconfigured transmission power, the MAC-CE activating an SP CSI-IM for the CLI or SI measurement, use of a different QCL D for an SP CSI-IM measurement occasion, the MAC-CE activating SP SRS and SP CSI-IM resources for the CLI or SI measurement, L2 CLI reporting, a joint MAC-CE triggering SP CSI-IM and CLI reporting, or computing and reporting CL with an aggressor UE based on an average transmission power of interference signal. The means may be one or more of the components of the apparatus 1502 configured to perform the functions recited by the means. As described supra, the apparatus 1502 may include the TX Processor 368, the RX Processor 356, and the controller/processor 359. As such, in one configuration, the means may be the TX Processor 368, the RX Processor 356, and the controller/processor 359 configured to perform the functions recited by the means.

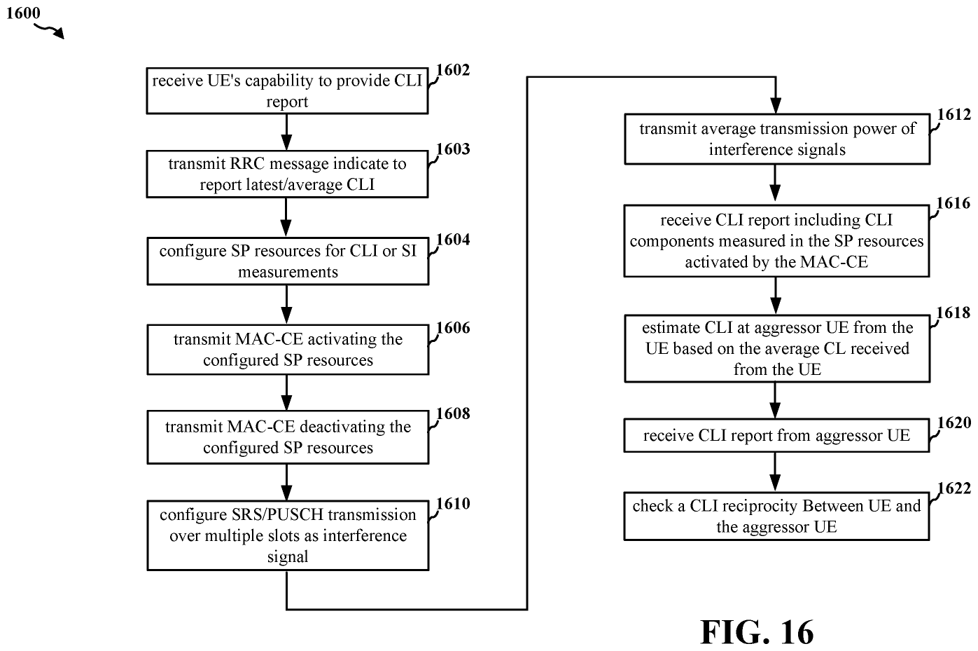

FIG. 16 is a flowchart 1600 of a method of wireless communication. The method may be performed by a base station (e.g., the base station 102/180; the apparatus 1802). The base station may configure SP resources for a UE to perform a CLI measurement, and the base station may receive, from the UE, a CLI report including CLI components indicating the CLI values or measurements from the interference signal received in the SP resources.

At 1602, the base station may transmit an RRC messaging including a CLI report configuration that indicates for the UE to report one of the most recent CLI measurements or a filtered CLI value over all the CLI measurements in the CLI report when the first MAC-CE configures the UE with P or SP CSI-IM resources. That is, the base station may indicate the UE to report the most recent CLI measurements or an average of (or filtered) the CLI measurements during the RRC configuration (e.g., as at 1208). The indication may be transmitted as an RRC message to the UE. For example, at 1208, the base station 1204 may transmit an RRC messaging including a CLI report configuration that indicates for the UE 1202 to report one of the most recent CLI measurements or a filtered CLI value over all the CLI measurements in the CLI report when the first MAC-CE configures the UE 1202 with P or SP CSI-IM resources. Furthermore, 1602 may be performed by a CLI component 1842.

At 1603, the base station may receive, from the UE, an indication whether the UE has the capability related to the SP CLI reporting and the activation of the SP CLI reporting. That is, the base station may receive an indication from the UE whether the UE has the capability related to the SP CLI and/or SI reporting and the activation of the SP CLI and/or SI reporting (e.g., as at 1209). The UE may indicate whether the UE supports one or more of a MAC-CE activating an SRS for the CLI or SI measurement with a maximum transmission power, the MAC-CE activating an SP CSI-IM for the CLI and/or SI measurements, use of a different QCL D for an SP SI-IM measurement occasion, a MAC-CE activating SP CSI-IM and/or SP SRS resources for the CLI and/or SI measurement, L2 CLI reporting, a joint MAC-CE triggering SP CSI-IM and CLI reporting, or a CLI reciprocity. The indication may be received as an RRC message from the UE. For example, at 1209, the base station 1204 may receive, from the UE 1202, an indication whether the UE 1202 has the capability related to the SP CLI reporting and the activation of the SP CLI reporting. Furthermore, 1614 may be performed by the CLI component 1842.

At 1604, the base station may configure the UE with one or more SP CSI-IM resources for the CLI and/or SI measurements (e.g., as at 1210). The base station may also configure the aggressor UE with SP SRS resources (e.g., as at 1210′). The base station may activate (or select) at least one configuration from the set of configurations of the at least one SP CLI or SI measurement. The base station may transmit the configuration via the RRC messages transmitted from the base station to the UE. For example, at 1210, the base station 1204 may configure the UE 1202 with SP CSI-IM resources for CLI and/or SI measurements. Furthermore, 1604 may be performed by a CSI-IM resources managing component 1840.

At 1606, the base station may transmit a MAC-CE to the UE, activating the one or more SP resources for the CLI and/or SI measurements configured at 1604 (e.g., as at 1212). The base station may also transmit the MAC-CE to the aggressor UE to activate the SP SRS resources configured at 1604 (e.g., as at 1212′). That is, the base station may configure a set of configurations of the at least one SP CLI or SI measurement, and activate (or select) at least one configuration from the set of configurations of the at least one SP CLI or SI measurement. The base station may transmit the MAC-CE activating the SP CSI-IM resources to also trigger the CLI reporting. For example, the MAC-CE activating the SP CSI-IM resources may also trigger the SP CLI reporting based on the triggered SP CSI-IM resources. Also, the base station may configure a set of configurations of the at least one SP CLI or SI measurement, and activate (or select) at least one configuration from the set of configurations of the at least one SP CLI or SI measurement. The base station may transmit the MAC-CE activating the SP CSI-IM resources to also trigger the CLI reporting. For example, the MAC-CE activating the SP CSI-IM resources may also trigger the SP CLI reporting based on the triggered SP CSI-IM resources. For example, at 1212, the base station 1204 may transmit a MAC-CE to the UE 1202, activating the SP resources for CLI and/or SI measurements configured at 1210, and at 1212′, the base station 1204 may also transmit MAC-CE to the aggressor UE 1206 to activate the SP SRS resources configured at 1210′. Furthermore, 1606 may be performed by the CSI-IM resources managing component 1840.

At 1608, the base station may transmit a MAC-CE deactivating the configured one or more SP resources, which were activated at 1606 (e.g., as at 1216). The deactivating MAC-CE may also activate the CLI and/or SI report. The CLI and/or SI report activated by the deactivating MAC-CE may be received via the uplink MAC-CE, and the CLI and/or SI report may include an average CLI. The UE may receive the MAC-CE deactivating the configured SP resources, stop performing the CLI and/or SI measurements in the SP SRS resources and reporting the CLI report. For example, at 1216, the base station 1204 may transmit a MAC-CE deactivating the configured SP resources, which were activated at 1212. Furthermore, 1608 may be performed by the CSI-IM resources managing component 1840.

At 1610, the base station may configure the aggressor UE with the SRS or the PUSCH transmission over multiple slots to the base station (e.g., as at 1218). For example, at 1218, the base station 1204 may configure the aggressor UE 1206 with the SRS or the PUSCH transmission over multiple slots to the base station 1204. Furthermore, 1610 may be performed by the CSI-IM resources managing component 1840.

At 1612, the base station may inform the UE with an average transmission power of the aggressor UE in the CLI measuring occasions (e.g., as at 1220). That is, the UE may be informed, by the base station, of the average transmission power of the aggressor UE in the CLI measuring occasions. For example, at 1220, the base station 1204 may inform the UE 1202 with an average transmission power of the aggressor UE 1206 in the CLI measuring occasions. Furthermore, 1612 may be performed by the CLI component 1842.

At 1616, the base station may receive the CLI report, including the CLI components indicating the CLI values or measurements from the interference signal received in the SP resources activated by the MAC-CE. That is, the base station may receive, from the UE, a CLI report, including CLI components indicating the CLI values or measurements from the interference signal received in the SP resources activated by the MAC-CE (e.g., as at 1226). The CLI report may be received via the uplink MAC-CE. The CLI report may be transmitted in response to triggering events, including the measured interference exceeding a certain threshold, a change in the CLI measured by a certain factor at the expiration of a timer configured at 1602, a periodic timer configured at 1602, and/or deactivation of the SP CSI-IM resource set for the CLI measurement transmitted at 1608. Also, the CLI reporting may include the average CL estimated based on the measurements of the CLI and the average transmission power of the aggressors UE received at 1612. The CLI reporting and the estimated average CL may be received on different MAC-CE occasions. For example, at 1226, the base station 1204 may receive the CLI report, including the CLI components indicating the CLI values or measurements from the interference signal received in the SP resources activated by the MAC-CE, 1616 may be performed by the CLI component 1842.

At 1618, the base station may estimate the CLI at the aggressor UE from the UE based on the average CL estimated and received from the UE. That is, the base station may estimate the CLI at the aggressor UE from the UE based on the average CL estimated and received from the UE at 1616 (e.g., as at 1228). For example, at 1228, the base station 1204 may estimate the CLI at the aggressor UE 1206 from the UE 1202 based on the average CL estimated at 1214 and received from the UE 1202 at 1226. Furthermore, 1618 may be performed by the CLI component 1842.

At 1620, the base station may receive a CLI report, including an estimated CL based on the interference with the UE (e.g., as at 1230). For example, at 1230, the base station 1204 may receive a CLI report, including an estimated CL based on the interference with the UE 1202. Furthermore, 1620 may be performed by the CLI component 1842.

At 1622, the base station may check the CLI reciprocity between the UE and the aggressor UE based on the estimated CLs reported from the UE and the aggressor UE (e.g., as at 1232). That is, the base station may check the CLI reciprocity by comparing the estimated CL reported from the UE at 1616, and the estimated CL reported from the aggressor UE 1206 at 1620. For example, at 1232, the base station 1204 may check the CLI reciprocity between the UE 1202 and the aggressor UE 1206 based on the estimated CLs reported from the UE 1202 and the aggressor UE 1206. Furthermore, 1622 may be performed by the CLI component 1842.

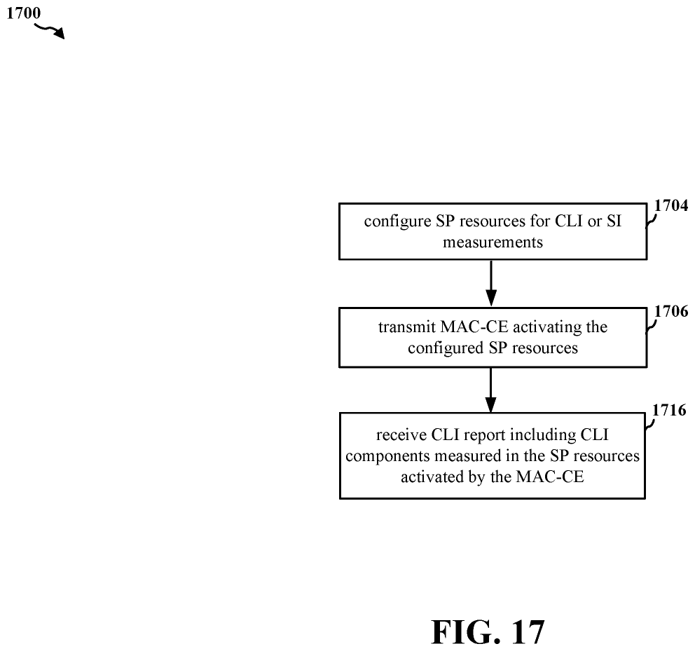

FIG. 17 is a flowchart 1700 of a method of wireless communication. The method may be performed by a base station (e.g., the base station 102/180; the apparatus 1802). The base station may configure SP resources for a UE to perform a CLI measurement, and the base station may receive, from the UE, a CLI report including CLI components indicating the CLI values or measurements from the interference signal received in the SP resources.

At 1704, the base station may configure the UE with one or more SP CSI-IM resources for the CLI and/or SI measurements (e.g., as at 1210). The base station may also configure the aggressor UE with SP SRS resources (e.g., as at 1210′). The base station may activate (or select) at least one configuration from the set of configurations of the at least one SP CLI or SI measurement. The base station may transmit the configuration via the RRC messages transmitted from the base station to the UE. For example, at 1210, the base station 1204 may configure the UE 1202 with SP CSI-IM resources for CLI and/or SI measurements. Furthermore, 1704 may be performed by a CSI-IM resources managing component 1840.

At 1706, the base station may transmit a MAC-CE to the UE, activating the one or more SP resources for the CLI and/or SI measurements configured at 1704 (e.g., as at 1212). The base station may also transmit the MAC-CE to the aggressor UE to activate the SP SRS resources configured at 1704 (e.g., as at 1212′). That is, the base station may configure a set of configurations of the at least one SP CLI or SI measurement, and activate (or select) at least one configuration from the set of configurations of the at least one SP CLI or SI measurement. The base station may transmit the MAC-CE activating the SP CSI-IM resources to also trigger the CLI reporting. For example, the MAC-CE activating the SP CSI-IM resources may also trigger the SP CLI reporting based on the triggered SP CSI-IM resources. Also, the base station may configure a set of configurations of the at least one SP CLI or SI measurement, and activate (or select) at least one configuration from the set of configurations of the at least one SP CLI or SI measurement. The base station may transmit the MAC-CE activating the SP CSI-IM resources to also trigger the CLI reporting. For example, the MAC-CE activating the SP CSI-IM resources may also trigger the SP CLI reporting based on the triggered SP CSI-IM resources. For example, at 1212, the base station 1204 may transmit a MAC-CE to the UE 1202, activating the SP resources for CLI and/or SI measurements configured at 1210, and at 1212′, the base station 1204 may also transmit MAC-CE to the aggressor UE 1206 to activate the SP SRS resources configured at 1210′. Furthermore, 1706 may be performed by the CSI-IM resources managing component 1840.

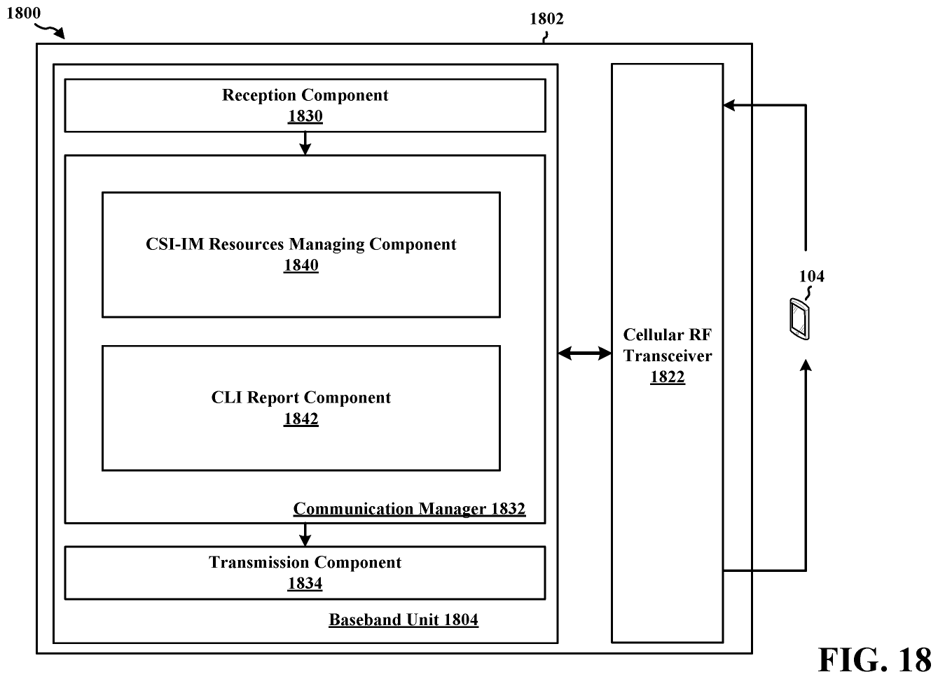

At 1716, the base station may receive the CLI report, including the CLI components indicating the CLI values or measurements from the interference signal received in the SP resources activated by the MAC-CE. That is, the base station may receive, from the UE, a CLI report, including CLI components indicating the CLI values or measurements from the interference signal received in the SP resources activated by the MAC-CE (e.g., as at 1226). The CLI report may be received via the uplink MAC-CE. The CLI report may be transmitted in response to triggering events, including the measured interference exceeding a certain threshold, a change in the CLI measured by a certain factor at the expiration of a timer configured at 1702, a periodic timer configured at 1702, and/or deactivation of the SP CSI-IM resource set for the CLI measurement transmitted at 1708. Also, the CLI reporting may include the average CL estimated based on the measurements of the CLI and the average transmission power of the aggressors UE received at 1712. The CLI reporting and the estimated average CL may be received on different MAC-CE occasions. For example, at 1226, the base station 1204 may receive the CLI report, including the CLI components indicating the CLI values or measurements from the interference signal received in the SP resources activated by the MAC-CE, 1716 may be performed by the CLI component 1842. FIG. 18 is a diagram 1800 illustrating an example of a hardware implementation for an apparatus 1802. The apparatus 1802 may be a base station, a component of a base station, or may implement base station functionality. In some aspects, the apparatus 1502 may include a baseband unit 1804. The baseband unit 1804 may communicate through a cellular RF transceiver 1822 with the UE 104. The baseband unit 1804 may include a computer-readable medium/memory. The baseband unit 1804 is responsible for general processing, including the execution of software stored on the computer-readable medium/memory. The software, when executed by the baseband unit 1804, causes the baseband unit 1804 to perform the various functions described supra. The computer-readable medium/memory may also be used for storing data that is manipulated by the baseband unit 1804 when executing software. The baseband unit 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband unit 1804. The baseband unit 1804 may be a component of the base station 310 and may include the memory 376 and/or at least one of the TX processor 316, the RX processor 370, and the controller/processor 375.

The communication manager 1832 includes a CSI-IM resources managing component 1840 that is configured to configure the UE with one or more SP CSI-IM resources for the CLI and/or SI measurements, transmit a MAC-CE to the UE, activating the one or more SP resources for the CLI and/or SI measurements configured, transmit a MAC-CE deactivating the configured one or more SP resources which were activated, and configure the aggressor UE with the SRS or the PUSCH transmission over multiple slots to the base station, e.g., as described in connection with 1604, 1606, 1608, 1610, 1704, and 1706. The communication manager 1832 further includes a CLI component 1842 that is configured to may indicate the UE to report the most recent CLI measurements or an average of (or filtered) the CLI measurements during the RRC configuration, receive an indication from the UE whether the UE has the capability related to the SP CLI and/or SI reporting and the activation of the SP CLI and/or SI reporting, inform the UE with an average transmission power of the aggressor UE in the CLI measuring occasions, receive, from the UE, a CLI report including CLI components indicating the CLI values or measurements from the interference signal receive in the SP resources activated by the MAC-CE, estimate the CLI at the aggressor UE from the UE 1202 based on the average CL estimated and received from the UE, receive a CLI report including an estimated CL based on the interference with the UE, and check the CLI reciprocity between the UE and the aggressor UE based on the estimated CLs reported from the UE and the aggressor UE, e.g., as described in connection with 1602, 1603, 1612, 1616, 1618, 1620, 1622, and 1716.

The apparatus may include additional components that perform each of the blocks of the algorithm in the flowcharts of FIGS. 12, 16, and 17. As such, each block in the flowcharts of FIGS. 12, 16, and 17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1802 may include a variety of components configured for various functions. In one configuration, the apparatus 1802, and in particular the baseband unit 1804, includes means for configuring, for a first UE, at least one SP resources for a CLI or SI measurement, and means for transmitting, to the first UE, a first MAC-CE activating at least one configured SP resource for the CLI or SI measurement. The apparatus 1802 includes means for receiving, from the first UE, a CLI report including at least one CLI component measured from at least one interference signal received in the SP resources activated by the MAC-CE. The apparatus 1802 includes means for transmitting a second MAC-CE to deactivate the SP resource, where the second MAC-CE triggers a CLI report, means for receiving the CLI report including an average CLI in an uplink MAC-CE from the first UE, and means for transmitting, to the first UE, average transmission power of at least one interference signal, and receive, from the first UE, an average CL based on at least one CLI component measured in the SP resources and the received average transmission power. The apparatus 1802 includes means for configuring a second UE with SRS or PUSCH transmission over the multiple slots as the at least one interference signal, means for estimating a CLI at the second UE from the first UE based on the average CL received from the first UE, means for configuring the second UE to report a CLI report including the at least one CLI component measured from the at least one interference signal received from the first UE in the SP resource activated by the MAC-CE, receiving the CLI report from the second UE, and checking a CLI reciprocity between the first UE and the second UE by comparing the estimated CLI and the CLI report received from the second UE. The apparatus 1802 includes means for transmitting an RRC messaging including a CLI report configuration that indicates for the first UE to report one of the most recent CLI measurements or a filtered CLI value over all the CLI measurements in the CLI report when the first MAC-CE configures the first UE with P or SP CSI-IM resources. The apparatus 1802 includes means for receiving an indication from the first UE during an RRC configuration, whether the first UE supports at least one of the MAC-CE activating a SRS for the CLI or SI measurement with a maximum transmission power, the MAC-CE activating an SP CSI-IM for the CLI or SI measurement, use of a different QCL D for an SP CSI-IM measurement occasion, the MAC-CE activating SP SRS and SP CSI-IM resources for the CLI or SI measurement, L2 CLI reporting, a joint MAC-CE triggering SP CSI-IM and CLI reporting, or computing and reporting CL with an aggressor UE based on an average transmission power of interference signal. The means may be one or more of the components of the apparatus 1802 configured to perform the functions recited by the means. As described supra, the apparatus 1802 may include the TX Processor 316, the RX Processor 370, and the controller/processor 375. As such, in one configuration, the means may be the TX Processor 316, the RX Processor 370, and the controller/processor 375 configured to perform the functions recited by the means.

According to the examples of the current disclosure, a UE may receive a configuration of one or more SP resources for a CLI and/or SI measurement, receive a first MAC-CE activating at least one configured SP resources for the CLI measurement or SI measurement from a base station, and perform a CLI or SI measurement activity in the at least one configured SP resources activated by the MAC-CE. The UE may report a CLI report, including at least one CLI component measured from at least one interference signal received in the SP resources activated by the MAC-CE to the base station. The UE may estimate average CL based on an average transmission power of the interference signal over multiple slots, and the base station may use the estimated average CL to determine CLI for other UEs based on CLI reciprocity.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to receive, from a base station, a configuration of at least one SP resources for a CLI or SI measurement, receive, from the base station, a first MAC-CE activating at least one configured SP resources for the CLI measurement or SI measurement, and perform a CLI or SI measurement activity in the at least one configured SP resources activated by the MAC-CE.

Aspect 2 is the apparatus of aspect 1, where the at least one configured SP resources activated by the MAC-CE includes an SP SRS resource.

Aspect 3 is the apparatus of aspect 2, where the MAC-CE indicates that the SP SRS resource is activated for the CLI measurement.

Aspect 4 is the apparatus of any of aspects 2 and 3, where the MAC-CE indicates a transmission power for the SP SRS resource, where performing the CLI measurement activity includes receiving an SP SRS from an aggressor UE based on the transmission power indicated in the MAC-CE.

Aspect 5 is the apparatus of any of aspects 1 to 4, where the at least one configured SP resource activated by the MAC-CE includes an SP CSI-IM resource.

Aspect 6 is the apparatus of aspect 5, where the at least one configured SP resource activated by the MAC-CE further includes an SP CSI-RS resource.

Aspect 7 is the apparatus of aspect 6, where the MAC-CE activates the SP CSI-IM resource separate from activation of or deactivation of the SP CSI-RS resource.

Aspect 8 is the apparatus of aspect 7, where the MAC-CE activating the SP CSI-IM includes TCI state list for the activated SP CSI-IM resource.

Aspect 9 is the apparatus of any of aspects 1 to 8, where the first MAC-CE activates an SP SRS resource and an SP CSI-IM resource.

Aspect 10 is the apparatus of any of aspects 1 to 9, where the at least one processor and the memory are further configured to report, to the base station, a CLI report or an SI report including at least one CLI component or SI component measured from at least one interference signal received in the SP resources activated by the MAC-CE.

Aspect 11 is the apparatus of aspect 10, where the CLI report is provided in response to at least one of the at least one CLI component exceeding a threshold interference value, a change in the at least one CLI component after expiration of a timer, a periodic timer, or deactivation of the SP resources for the CLI measurement.

Aspect 12 is the apparatus of any of aspects 10 and 11, where the CLI report is transmitted to the base station via an uplink MAC-CE.

Aspect 13 is the apparatus of aspect 12, where the uplink MAC-CE includes at least one CLI value field and at least one CSI-IM resource set associated with the at least one CLI value field.

Aspect 14 is the apparatus of any of aspects 12 and 13, where the uplink MAC-CE includes at least one sub-band CLI value for each CSI-IM resources.

Aspect 15 is the apparatus of any of aspects 1 to 14, where the MAC-CE that activates the SP resource triggers a CLI or SI report, and where the CLI or SI report is reported via at least one of a PUCCH or an uplink MAC-CE to the base station.

Aspect 16 is the apparatus of any of aspects 1 to 15, where the at least one processor and the memory are further configured to receive a second MAC-CE to deactivate the SP resource, where the second MAC-CE triggers a CLI report, and transmit the CLI report, including an average CLI in an uplink MAC-CE to the base station.

Aspect 17 is the apparatus of any of aspects 1 to 16, where the at least one processor and the memory are further configured to receive, from the base station, average transmission power of at least one interference signal from an aggressor UE, and estimate an average CL with the aggressor UE based on at least one CLI component measured in the SP resources and the received average transmission power, where the at least one interference signal includes interference signals received over multiple slots.

Aspect 18 is the apparatus of any of aspects 1 to 17, where the at least one processor and the memory are further configured to receive an RRC messaging including a CLI report configuration that indicates for the UE to report one of the most recent CLI measurements or a filtered CLI value over all the CLI measurements in the CLI report when the first MAC-CE configures the UE with P or SP CSI-IM resources.

Aspect 19 is the apparatus of aspect 18, where the filtered CLI value over all the CLI measurements includes an average CLI value over all the CLI measurements.

Aspect 20 is the apparatus of any of aspects 1 to 19, where the at least one processor and the memory are further configured to indicate to the base station, during an RRC configuration, whether the UE supports at least one of the MAC-CE activating a SRS for the CLI or SI measurement with a preconfigured transmission power, the MAC-CE activating an SP CSI-IM for the CLI or SI measurement, use of a different QCL D for an SP CSI-IM measurement occasion, the MAC-CE activating SP SRS and SP CSI-IM resources for the CLI or SI measurement, L2 CLI reporting, a joint MAC-CE triggering SP CSI-IM and CLI reporting, or computing and reporting CL with an aggressor UE based on an average transmission power of interference signal.

Aspect 21 is a method of wireless communication for implementing any of aspects 1 to 20.

Aspect 22 is an apparatus for wireless communication including means for implementing any of aspects 1 to 20.

Aspect 23 is a computer-readable medium storing computer executable code, where the code when executed by a processor causes the processor to implement any of aspects 1 to 20.

Aspect 24 is an apparatus for wireless communication including at least one processor coupled to a memory and configured to configure, for a first UE, at least one SP resources for a CLI or SI measurement, and transmit, to the first UE, a first MAC-CE activating at least one configured SP resource for the CLI or SI measurement.

Aspect 25 is the apparatus of aspect 24, where the at least one configured SP resources activated by the MAC-CE includes an SP SRS resource.

Aspect 26 is the apparatus of aspect 25, where the MAC-CE indicates that the SP SRS resource is activated for the CLI measurement.

Aspect 27 is the apparatus of any of aspects 24 to 26, where the at least one configured SP resource activated by the MAC-CE includes an SP CSI-IM resource.

Aspect 28 is the apparatus of aspect 27, where the at least one configured SP resource activated by the MAC-CE, further includes an SP CSI-RS resource.

Aspect 29 is the apparatus of aspects 28, where the MAC-CE activates the SP CSI-IM separate from activation of or deactivation of the SP CSI-RS resource.

Aspect 30 is the apparatus of aspect 29, where the MAC-CE activating the SP CSI-IM includes TCI list for the activated SP CSI-IM resource.

Aspect 31 is the apparatus of any of aspects 24 to 30, where the at least one processor and the memory are further configured to receive, from the first UE, a CLI report or an SI report including at least one CLI component or SI component measured from at least one interference signal received in the SP resources activated by the MAC-CE.

Aspect 32 is the apparatus of aspect 31, where the first MAC-CE activates an SP SRS resource and an SP CSI-IM resource.

Aspect 33 is the apparatus of aspect 32, where the MAC-CE indicates a transmission power for the SP SRS resource, where the CLI report is generated based on the SP SRS transmitted by a second UE based on the transmission power in the SP SRS resource.

Aspect 34 is the apparatus of aspect 33, where the CLI report is provided in response to at least one of at least one CLI component exceeding a threshold interference value, a change in the at least one CLI component after expiration of a timer, a periodic timer, or deactivation of the SP resources for the CLI measurement.

Aspect 35 is the apparatus of any of aspects 33 and 34, where the CLI report is received from the first UE via an uplink MAC-CE.

Aspect 36 is the apparatus of aspect 35, where the uplink MAC-CE includes at least one CLI value field and at least one CSI-IM resource set associated with the at least one CLI value field.

Aspect 37 is the apparatus of any of aspects 35 to 36, where the uplink MAC-CE includes at least one sub-band CLI value for each CSI-IM resources.

Aspect 38 is the apparatus of any of aspects 24 to 37, where the MAC-CE that activates the SP resource triggers a CLI or SI report, and the CLI or SI report is received via at least one of a PUCCH or an uplink MAC-CE from the first UE.

Aspect 39 is the apparatus of any of aspects 24 to 38, where the at least one processor and the memory are further configured to transmit a second MAC-CE to deactivate the SP resource, where the second MAC-CE triggers a CLI report, and receive the CLI report including an average CLI in an uplink MAC-CE from the first UE.

Aspect 40 is the apparatus of any of aspects 24 to 39, where the at least one processor and the memory are further configured to transmit, to the first UE, average transmission power of at least one interference signal, and receive, from the first UE, an average CL based on at least one CLI component measured in the SP resources and the received average transmission power, where the at least one interference signal includes interference signals received over multiple slots.

Aspect 41 is the apparatus of aspect 40, where the at least one processor and the memory are further configured to configure a second UE with SRS or PUSCH transmission over the multiple slots as the at least one interference signal, and estimate a CLI at the second UE from the first UE based on the average CL received from the first UE.

Aspect 42 is the apparatus of aspect 41, where the at least one processor and the memory are further configured to configure the second UE to report a CLI report including the at least one CLI component measured from the at least one interference signal received from the first UE in the SP resource activated by the MAC-CE, receive the CLI report from the second UE, and check a CLI reciprocity between the first UE and the second UE by comparing the estimated CLI and the CLI report received from the second UE.

Aspect 43 is the apparatus of any of aspects 24 to 42, where the at least one processor and the memory are further configured to transmit an RRC messaging including a CLI report configuration that indicates for the first UE to report one of the most recent CLI measurements or a filtered CLI value over all the CLI measurements in the CLI report when the first MAC-CE configures the first UE with P or SP CSI-IM resources.

Aspect 44 is the apparatus of aspect 43, where the filtered CLI value over all the CLI measurements, includes an average CLI value over all the CLI measurements.

Aspect 45 is the apparatus of any of aspects 24 to 44, where the at least one processor and the memory are further configured to receive an indication from the first UE during an RRC configuration, whether the first UE supports at least one of the MAC-CE activating a SRS for the CLI or SI measurement with a maximum transmission power, the MAC-CE activating an SP CSI-IM for the CLI or SI measurement, use of a different QCL D for an SP CSI-IM measurement occasion, the MAC-CE activating SP SRS and SP CSI-IM resources for the CLI or SI measurement, L2 CLI reporting, a joint MAC-CE triggering SP CSI-IM and CLI reporting, or computing and reporting CL with an aggressor UE based on an average transmission power of interference signal.

Aspect 46 is a method of wireless communication for implementing any of aspects 24 to 45.

Aspect 47 is an apparatus for wireless communication including means for implementing any of aspects 24 to 45.

Aspect 48 is a computer-readable medium storing computer executable code, where the code when executed by a processor causes the processor to implement any of aspects 24 to 45.

What is claimed is:

1. An apparatus for wireless communication of a user equipment (UE), comprising:
a memory; and
at least one processor coupled to the memory, the at least one processor and the memory configured to:
receive, from a base station, a configuration of at least one semi-persistent (SP) resources for a cross-link interference (CLI) measurement or a self-interference (SI) measurement;
receive, from the base station, a first medium access control (MAC) control element (CE) (MAC-CE) activating at least one configured SP resource for the CLI measurement or the SI measurement;
perform a measurement activity for the CLI measurement or the SI measurement in the at least one configured SP resource activated by the first MAC-CE; and
report, to the base station, a CLI report or an SI report including at least one CLI component or SI component measured from at least one interference signal received in the at least one configured SP resource that is activated by the first MAC-CE.

2. The apparatus of claim 1, further comprising a transceiver coupled to the at least one processor,
wherein the at least one configured SP resource activated by the first MAC-CE includes an SP sounding reference signal (SRS) resource for the CLI measurement.

3. The apparatus of claim 2, wherein the first MAC-CE indicates a transmission power for the SP SRS resource, and to perform the measurement activity, the memory and the at least one processor are configured to receive an SP SRS from an aggressor UE based on the transmission power indicated in the first MAC-CE.

4. The apparatus of claim 1, wherein the at least one configured SP resource that is activated by the first MAC-CE includes an SP channel state information interference measurement (SP CSI-IM) resource.

5. The apparatus of claim 4, wherein the at least one configured SP resource that is activated by the first MAC-CE further includes an SP channel state information reference signal (SP CSI-RS) resource.

6. The apparatus of claim 5, wherein the first MAC-CE activates the SP CSI-IM resource separate from activation of or deactivation of the SP CSI-RS resource.

7. The apparatus of claim 6, wherein the first MAC-CE activating the SP CSI-IM resource includes a TCI state list for the SP CSI-IM resource that is activated by the MAC-CE.

8. The apparatus of claim 1, wherein the first MAC-CE activates an SP SRS resource and an SP CSI-IM resource.

9. The apparatus of claim 1, wherein the first MAC-CE that activates the at least one configured SP resource triggers the CLI report or the SI report.

10. The apparatus of claim 1, wherein the memory and the at least one processor are further configured to:
receive a second MAC-CE to deactivate the at least one configured SP resource, wherein the second MAC-CE triggers an additional CLI report; and
transmit the additional CLI report, including an average CLI in an uplink MAC-CE to the base station.

11. The apparatus of claim 1, wherein the memory and the at least one processor are further configured to:
receive, from the base station, an average transmission power of the at least one interference signal from an aggressor UE; and
estimate an average coupling loss (CL) with the aggressor UE based on the at least one CLI component measured in the at least one SP resource activated by the first MAC-CE and the average transmission power received from the base station,
wherein the at least one interference signal includes interference signals received over multiple slots.

12. The apparatus of claim 1, wherein the memory and the at least one processor are further configured to:
receive a radio resource control (RRC) messaging including a CLI report configuration that indicates for the UE to report one or more of a most recent CLI measurement or a filtered CLI value over a set of CLI measurements in the CLI report when the first MAC-CE configures the UE with periodic (P) or SP CSI-IM resources.

13. An apparatus for wireless communication at a base station, comprising:
a memory; and
at least one processor coupled to the memory, the at least one processor and the memory configured to:
configure, for a first user equipment (UE), at least one semi-persistent (SP) resource for a cross-link interference (CLI) measurement or a self-interference (SI) measurement;
transmit, to the first UE, a first medium access control (MAC) control element (CE) (MAC-CE) activating at least one configured SP resource for the CLI measurement or the SI measurement; and
receive from the first UE, a CLI report or an SI report including at least one CLI component or SI component measured from at least one interference signal received in the at least one configured SP resource activated by the first MAC-CE.

14. The apparatus of claim 13, further comprising a transceiver coupled to the at least one processor,
wherein the at least one configured SP resource that is activated by the first MAC-CE includes an SP sounding reference signal (SRS) resource.

15. The apparatus of claim 14, wherein the first MAC-CE indicates that the SP SRS resource is activated for the CLI measurement.

16. The apparatus of claim 14, wherein the first MAC-CE indicates a transmission power for the SP SRS resource, wherein the CLI report is based on an SP SRS of a second UE based on the transmission power in the SP SRS resource.

17. The apparatus of claim 13, wherein the at least one configured SP resource activated by the first MAC-CE includes at least one of an SP SRS resource or an SP channel state information interference measurement (SP CSI-IM) resource.

18. The apparatus of claim 17, wherein the at least one configured SP resource that is activated by the first MAC-CE, further includes an SP channel state information reference signal (SP CSI-RS) resource.

19. The apparatus of claim 18, wherein the first MAC-CE activates the SP CSI-IM separate from activation of or deactivation of the SP CSI-RS resource.

20. The apparatus of claim 19, wherein the first MAC-CE activating the SP CSI-IM includes a TCI list for the SP CSI-IM resource activated by the first MAC-CE.

21. The apparatus of claim 13, wherein the memory and the at least one processor are further configured to:
transmit a second MAC-CE to deactivate the at least one configured SP resource that is activated by the first MAC-CE, wherein the second MAC-CE triggers an additional CLI report; and
receive the additional CLI report including an average CLI in an uplink MAC-CE from the first UE.

22. The apparatus of claim 13, wherein the memory and the at least one processor are further configured to:
transmit, to the first UE, an average transmission power of the at least one interference signal; and
receive, from the first UE, an average coupling loss (CL) based on the at least one CLI component measured in the at least one configured SP resources and the received average transmission power,
wherein the at least one interference signal includes interference signals received over multiple slots.

23. The apparatus of claim 22, wherein the memory and the at least one processor are further configured to:
configure a second UE for an SRS transmission or a PUSCH transmission over the multiple slots as the at least one interference signal; and
estimate a CLI at the second UE caused by the first UE based on an average CLI received from the first UE.

24. The apparatus of claim 23, wherein the memory and the at least one processor are further configured to:
configure the second UE to report an additional CLI report including one or more one CLI component measured from at least one interference signal received from the first UE in the at least one configured SP resource that is activated by the first MAC-CE;
receive the additional CLI report from the second UE; and
check a CLI reciprocity between the first UE and the second UE by comparing the estimated CLI and the additional CLI report received from the second UE.

25. The apparatus of claim 13, wherein the memory and the at least one processor are further configured to:
transmit a radio resource control (RRC) messaging including a CLI report configuration that indicates for the first UE to report one or more of a most recent CLI measurement or a filtered CLI value over a set of CLI measurements in the CLI report when the first MAC-CE configures the first UE with periodic (P) or SP CSI-IM resources.

26. The apparatus of claim 25, wherein the filtered CLI value over the set of the CLI measurements includes an average CLI value over the set of CLI measurements.

27. The apparatus of claim 13, wherein the memory and the at least one processor are further configured to:
receive an indication from the first UE during a radio resource control (RRC) configuration, whether the first UE supports at least one of:
MAC-CE activation of a sounding reference signal (SRS) for the CLI or SI measurement with a maximum transmission power,
the MAC-CE activation of an SP channel state information interference measurement (CSI-IM) for the CLI measurement or the SI measurement,
use of a different quasi co-location D (QCL D) for an SP CSI-IM measurement occasion,
the MAC-CE activation of SP SRS and SP CSI-IM resources for the CLI measurement or the SI measurement,
layer 2 (L2) CLI reporting,
a joint MAC-CE triggering SP CSI-IM and CLI reporting, or
computing and reporting coupling loss (CL) with an aggressor UE based on an average transmission power of interference signal.

28. A method of wireless communication at a user equipment (UE), comprising:
receiving, from a base station, a configuration of at least one semi-persistent (SP) resource for a cross-link interference (CLI) measurement or a self-interference (SI) measurement;
receiving, from the base station, a first medium access control (MAC) control element (CE) (MAC-CE) activating at least one configured SP resource for the CLI measurement or the SI measurement;
performing a measurement activity for the CLI measurement or the SI measurement in the at least one configured SP resource that is activated by the first MAC-CE; and
reporting, to the base station, a CLI report including at least one CLI component measured from at least one interference signal received in the at least one configured SP resource that is activated by the first MAC-CE.

29. A method of wireless communication at a base station, comprising:
configuring, for a first user equipment (UE), at least one semi-persistent (SP) resources for a cross-link interference (CLI) measurement or self-interference (SI) measurement;
transmitting, to the first UE, a first medium access control (MAC) control element (CE) (MAC-CE) activating at least one configured SP resource for the CLI measurement or the SI measurement; and
receiving from the first UE, a CLI report including at least one CLI component measured from at least one interference signal received in the at least one configured SP resource that is activated by the first MAC-CE.

30. The method of claim 29, further comprising:
configuring a second UE for a SRS transmission or a PUSCH transmission over multiple slots as the at least one interference signal; and
estimating a CLI at the second UE from the first UE based on an average CLI received from the first UE.
